(19) United States
(12) Patent Application Publication
(10) Pub. No.: US 2024/0233246 A1
(43) Pub. Date: Jul. 11, 2024

(54) CURVE-CONDITIONED MEDICAL IMAGE SYNTHESIS

(71) Applicant: GE Precision Healthcare LLC, Waukesha, WI (US)

(72) Inventors: Faycal El Hanchi El Amrani, Paris (FR); Etienne Perot, Versailles (FR)

(21) Appl. No.: 18/398,763

(22) Filed: Dec. 28, 2023

Related U.S. Application Data
(60) Provisional application No. 63/479,050, filed on Jan. 9, 2023.

(51) Int. Cl. G06T 15/08; G06T 11/20; G06V 10/774; G06V 10/82

(52) U.S. Cl. CPC G06T 15/08; G06T 11/203; G06V 10/774; G06V 10/82; G06T 2210/41

(57) ABSTRACT

Systems/techniques that facilitate curve-conditioned medical image synthesis are provided. In various embodiments, a system can access a user-specified geometric curve. In various aspects, the system can generate, via execution of a first deep learning neural network on the user-specified geometric curve, a synthetic medical image whose visual characteristics are based on the user-specified geometric curve. In various instances, the system can render the synthetic medical image on an electronic display.

### RELATED APPLICATION

This application claims priority to U.S. Provisional Patent Application No. 63/479,050, filed Jan. 9, 2023, and entitled “CURVE-CONDITIONED MEDICAL IMAGE SYNTHESIS”, the entirety of which is incorporated herein by reference.

### TECHNICAL FIELD

The subject disclosure relates generally to medical image synthesis, and more specifically to curve-conditioned medical image synthesis.

### BACKGROUND

Machine learning models are often configured to perform inferencing tasks on medical images. Before such machine learning models can be deployed in clinical contexts, they must be trained. Such training can depend upon the availability of voluminous amounts of medical images. Privacy regulations and radiation exposure concerns can make it difficult to obtain voluminous amounts of authentic medical images. Such difficulty can be addressed by the generation of synthetic medical images. Existing techniques facilitate the generation of synthetic medical images via generative adversarial networks. Such existing techniques can create voluminous amounts of medical images that are synthetic yet realistic-looking. Although the visual content of a synthetic medical image generated by such existing techniques can be realistic-looking, it is often created at random. In other words, a user or technician has effectively no control at inference time over the particular visual content exhibited by a synthetic medical image generated by such existing techniques.

Systems or techniques that can facilitate synthesis of medical images with improved end-user control over the visual content of such medical images can be considered as desirable.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus or computer program products that facilitate curve-conditioned medical image synthesis are described.

According to one or more embodiments, a system is provided. The system can comprise a non-transitory computer-readable memory that can store computer-executable components. The system can further comprise a processor that can be operably coupled to the non-transitory computer-readable memory and that can execute the computer-executable components stored in the non-transitory computer-readable memory. In various embodiments, the computer-executable components can comprise an access component that can access a user-specified geometric curve. In various aspects, the computer-executable components can comprise an inference component that can generate, via execution of a first deep learning neural network on the user-specified geometric curve, a synthetic medical image whose visual characteristics are based on the user-specified geometric curve. In various instances, the computer-executable components can comprise a display component that can render the synthetic medical image on an electronic display.

According to one or more embodiments, a computer-implemented method is provided. In various embodiments, the computer-implemented method can comprise accessing, by a device operatively coupled to a processor, a user-specified geometric curve. In various aspects, the computer-implemented method can comprise generating, by the device and via execution of a first deep learning neural network on the user-specified geometric curve, a synthetic medical image whose visual characteristics are based on the user-specified geometric curve. In various instances, the computer-implemented method can comprise rendering, by the device, the synthetic medical image on an electronic display.

According to one or more embodiments, a computer program product for facilitating curve-conditioned medical image synthesis is provided. In various embodiments, the computer program product can comprise a non-transitory computer-readable memory having program instructions embodied therewith. In various aspects, the program instructions can be executable by a processor to cause the processor to access a two-dimensional or three-dimensional curve. In various instances, the program instructions can be further executable to cause the processor to execute a deep learning neural network on the two-dimensional or three-dimensional curve, thereby yielding a synthetic medical image that depicts one or more anatomical structures that resemble the two-dimensional or three-dimensional curve. In various cases, the program instructions can be further executable to cause the processor to render the synthetic medical image on an electronic display.

### DESCRIPTION OF THE DRAWINGS

FIG. 1 illustrates a block diagram of an example, non-limiting system that facilitates curve-conditioned medical image synthesis in accordance with one or more embodiments described herein.

FIG. 2 illustrates a block diagram of an example, non-limiting system including a deep learning network and a synthetic medical image that facilitates curve-conditioned medical image synthesis in accordance with one or more embodiments described herein.

FIGS. 3-5 illustrate example, non-limiting block diagrams showing how a deep learning neural network can generate a synthetic medical image based on a geometric curve in accordance with one or more embodiments described herein.

FIG. 6 illustrates a block diagram of an example, non-limiting system including a training component, a training dataset, and another deep learning neural network that facilitates curve-conditioned medical image synthesis in accordance with one or more embodiments described herein.

FIG. 7 illustrates an example, non-limiting block diagram of a training dataset in accordance with one or more embodiments described herein.

FIG. 8 illustrates an example, non-limiting block diagram showing how a deep learning neural network can be trained in series with another deep learning neural network in accordance with one or more embodiments described herein.

FIG. 9 illustrates an example, non-limiting block diagram showing how a deep learning neural network can be trained without another deep learning neural network in accordance with one or more embodiments described herein.

FIG. 10 illustrates a flow diagram of an example, non-limiting computer-implemented method that facilitates curve-conditioned medical image synthesis in accordance with one or more embodiments described herein.

FIG. 11 illustrates a block diagram of an example, non-limiting operating environment in which one or more embodiments described herein can be facilitated.

FIG. 12 illustrates an example networking environment operable to execute various implementations described herein.

### DETAILED DESCRIPTION

The following detailed description is merely illustrative and is not intended to limit embodiments or application/uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Machine learning models (e.g., deep learning neural networks) are often configured to perform inferencing tasks (e.g., image classification, image segmentation, image denoising, image quality enhancement, landmark extraction, orientation determination) on medical images (e.g., computed tomography (CT) scanned images, magnetic resonance imaging (MRI) scanned images, positron emission tomography (PET) scanned images, X-ray scanned images, ultrasound scanned images).

Before such machine learning models can be deployed in clinical contexts, they must be trained (e.g., via supervised training, unsupervised training, or reinforcement learning). Such training can depend upon the availability of voluminous amounts of medical images. After all, training of a machine learning model can involve iteratively feeding the machine learning model training medical images (e.g., medical images from a designated training dataset) and incrementally updating internal parameters of the machine learning model based on the outputs it produces in response to those training medical images.

Privacy regulations and radiation exposure concerns can make it difficult to obtain voluminous amounts of authentic medical images. In particular, the desire to minimize or otherwise reduce the amounts of radiation to which medical patients are exposed can create a general tendency to perform as few medical scans on medical patients as possible, which can reduce the amount of authentic medical images available for training machine learning models. Additionally, the authentic medical images produced from those few medical scans that are performed are often subject to various governmental laws (e.g., such laws restrict the divulgation or use of such authentic medical images absent patient consent).

Such difficulty in obtaining authentic medical images can be addressed by instead utilizing synthetic medical images. That is, rather than using authentic medical images to train machine learning models, synthetic medical images can be used to train machine learning models. In particular, a synthetic medical image can be a medical image that was not created by scanning a real medical patient or that otherwise does not depict any portion of a real medical patient. For example, an authentic torso CT image can be an image generated by performing a CT scan on a torso of a real-world medical patient. In contrast, a synthetic torso CT image can be an image that appears to be a CT scanned image of a torso, but such torso can be artificial, can be fake, can be made-up, or can otherwise not belong to a real-world medical patient. Accordingly, privacy regulations and radiation exposure concerns can be inapplicable to synthetic medical images.

Existing techniques facilitate the generation of synthetic medical images via generative adversarial networks. More specifically, such existing techniques involve a generator, a discriminator, and a set of real (e.g., authentic) medical images. In such existing techniques, the generator is a deep learning neural network that is configured to receive as input a randomized array and to produce as output a synthetic medical image based on such inputted randomized array. Moreover, in such existing techniques, the discriminator is a deep learning neural network that is configured to receive as input a medical image and to classify such medical image as being real (e.g., not created by the generator) or instead as being synthetic (e.g., created by the generator). Internal parameters of both the generator and the discriminator can be updated by backpropagation driven by how accurately or how inaccurately the discriminator performs. In particular, the discriminator can be updated based on errors between its outputted classifications and corresponding ground-truth classifications, and the generator can be updated based on inverses of such errors. In other words, such training can cause the discriminator to become better at distinguishing real from synthetic medical images and can cause the generator to become better at producing realistic-looking medical images. Accordingly, such existing techniques can create voluminous amounts of medical images that are synthetic yet realistic-looking.

As the inventors of various embodiments described herein recognized, although the visual content of a synthetic medical image generated by such existing techniques can be realistic-looking, such visual content is created at random. Again, the generator of such existing techniques is configured to synthesize a medical image based on a randomized array. In other words, a user or technician that is operating the generator can create a synthetic medical image by feeding a randomized array to the generator. Thus, the present inventors recognized that, even though the generator is likely to produce as output a synthetic medical image that has realistic-looking visual content, the user or technician has effectively no control or influence over that visual content. For example, the user or technician cannot tell or command the generator to create a synthetic medical image that depicts a particular anatomical structure having a particular shape or a particular orientation.

Therefore, systems or techniques that can facilitate synthesis of medical images with improved end-user control over the visual content of such medical images can be considered as desirable.

Various embodiments described herein can address one or more of these technical problems. One or more embodiments described herein can include systems, computer-implemented methods, apparatus, or computer program products that can facilitate curve-conditioned medical image synthesis. In other words, the present inventors devised various techniques for synthesizing medical images based on curve conditionings. In still other words, the present inventors devised various techniques that can receive as input a given geometric curve (e.g., a two-dimensional curve defined in a plane, or a three-dimensional curve defined in three-space) specified by a user or technician and that can generate a synthetic medical image that is based on such given geometric curve. That is, the visual content of such synthetic medical image can resemble the given geometric curve (e.g., the synthetic medical image can depict an anatomical structure whose shape or orientation matches, tracks, follows, or is otherwise influenced by the given geometric curve). Accordingly, various embodiments described herein can enable a user or technician to easily and reliably exercise increased control or influence over the visual content of synthetic medical images.

Various embodiments described herein can be considered as a computerized tool (e.g., any suitable combination of computer-executable hardware or computer-executable software) that can facilitate curve-conditioned medical image synthesis. In various aspects, such computerized tool can comprise an access component, an inference component, or a display component.

In various embodiments, there can be a geometric curve. In various aspects, the geometric curve can be two-dimensional (e.g., can be a path traced by a point in two-space) or three-dimensional (e.g., can be a path traced by a point in three-space). In various instances, the geometric curve can be smooth (e.g., differentiable everywhere) or not smooth (e.g., not differentiable everywhere). In various cases, the geometric curve can exhibit any suitable length or any suitable shape (e.g., can have any suitable number of any suitable types of twists or turns). In various aspects, the geometric curve can be expressed in any suitable electronic data format. For example, the geometric curve can be expressed as a sequence of coordinates (e.g., Cartesian coordinates, polar coordinates, cylindrical coordinates, spherical coordinates) that identify particular points (e.g., in two-space or in three-space), where such particular points, when connected or coupled in sequence, collectively form the geometric curve. In various other aspects, the geometric curve can be expressed as one or more parametrized functions that identify such a sequence of coordinates based on a parameter argument. In various instances, the geometric curve can be specified by a user, technician, or operator of the computerized tool using any suitable human-computer interface device (e.g., keyboard, keypad, touchscreen, computer mouse). In still other aspects, the geometric curve can be depicted in an image (e.g., in a two-dimensional pixel array if the geometric curve is two-dimensional; or in a three-dimensional voxel array if the geometric curve is three-dimensional).

In various embodiments, there can be a randomized array. In various aspects, the randomized array can exhibit any suitable format or dimensionality (e.g., can be a one-dimensional vector of scalar values; can be a two-dimensional matrix of scalar values; or can be a three-dimensional tensor of scalar values). In any case, the numerical elements of the randomized array can have randomly-generated magnitudes (e.g., can have magnitudes that are randomly sampled from any suitable interval or range of real numbers).

In various embodiments, it can be desired to generate a synthetic medical image whose visual characteristics resemble or are otherwise based on the geometric curve. In various aspects, as described herein, the computerized tool can facilitate such medical image synthesis.

In various embodiments, the access component of the computerized tool can electronically receive or otherwise electronically access the geometric curve or the randomized array. In some aspects, the access component can electronically retrieve the geometric curve or the randomized array from any suitable centralized or decentralized data structures (e.g., graph data structures, relational data structures, hybrid data structures), whether remote from or local to the access component. In any case, the access component can electronically obtain or access the geometric curve or the randomized array, such that other components of the computerized tool can electronically interact with (e.g., read, write, edit, copy, manipulate) the geometric curve or the randomized array.

In various aspects, the inference component of the computerized tool can electronically store, maintain, control, or otherwise access a first deep learning neural network. In various instances, the first deep learning neural network can exhibit any suitable internal architecture. For example, the first deep learning neural network can include any suitable numbers of any suitable types of layers (e.g., input layer, one or more hidden layers, output layer, any of which can be convolutional layers, dense layers, non-linearity layers, pooling layers, batch normalization layers, or padding layers). As another example, the first deep learning neural network can include any suitable numbers of neurons in various layers (e.g., different layers can have the same or different numbers of neurons as each other). As yet another example, the first deep learning neural network can include any suitable activation functions (e.g., softmax, sigmoid, hyperbolic tangent, rectified linear unit) in various neurons (e.g., different neurons can have the same or different activation functions as each other). As still another example, the first deep learning neural network can include any suitable interneuron connections or interlayer connections (e.g., forward connections, skip connections, recurrent connections).

In any case, the first deep learning neural network can be configured, as described herein, to receive as input geometric curves and randomized arrays and to produce as output synthetic medical images. Accordingly, the inference component can electronically execute the first deep learning neural network on both the geometric curve and the randomized array, thereby yielding a synthetic medical image. More specifically, the inference component can concatenate the geometric curve with the randomized array, the inference component can feed such concatenation to an input layer of the first deep learning neural network, such concatenation can complete a forward pass through one or more hidden layers of the first deep learning neural network, and an output layer of the first deep learning neural network can compute the synthetic medical image based on activations generated by the one or more hidden layers.

In various aspects, the synthetic medical image can be any suitable two-dimensional pixel array or any suitable three-dimensional voxel array that appears or otherwise looks like an authentic medical image (e.g., the synthetic medical image can appear or look like a CT scanned image, an MRI scanned image, a PET scanned image, an X-ray scanned image, or an ultrasound scanned image). In various instances, the synthetic medical image can appear or otherwise seem to illustrate any suitable anatomical structure (e.g., spine, colon, blood vessel, tendon) that is based on the geometric curve. In other words, a shape, position, or orientation of the anatomical structure depicted by the synthetic medical image can resemble, track, mirror, match, or otherwise follow the shape, position, or orientation of the geometric curve. That is, the first deep learning neural network can be configured, as described herein, to cause the visual content of the synthetic medical image to be controlled or otherwise influenced by the geometric curve.

In various cases, the synthetic medical image can have the same format, size, or dimensionality as the randomized array. For example, if the randomized array is a two-dimensional matrix of scalar values, then the synthetic medical image can, in some cases, be a two-dimensional pixel array having the same number of rows and columns as the randomized array. As another example, if the randomized array is a three-dimensional tensor of scalar values, then the synthetic medical image can be a three-dimensional voxel array having the same number of rows, columns, and layers as the randomized array. However, in various other cases, the synthetic medical image can have a larger size, format, or dimensionality than the randomized array. For example, if the synthetic medical image is a two-dimensional pixel array, then the randomized array can, in some cases, be: a one-dimensional vector of scalar values; or a two-dimensional matrix of scalar values having fewer rows or fewer columns than the synthetic medical image. As another example, if the synthetic medical image is a three-dimensional voxel array, then the randomized array can, in some cases, be: a one-dimensional vector of scalar values; a two-dimensional matrix of scalar values; or a three-dimensional tensor of scalar values having fewer rows, fewer columns, or fewer layers than the synthetic medical image.

In various embodiments, the display component of the computerized tool can electronically render, on any suitable electronic display (e.g., computer screen, computer monitor, graphical user-interface), the synthetic medical image. Thus, a user, technician, or operator of the computerized tool can visually inspect or view the synthetic medical image as rendered on the electronic display.

To help cause the synthetic medical image to be accurate (e.g., to be realistic-looking and to resemble the geometric curve), the first deep learning neural network can undergo any suitable type or paradigm of training (e.g., supervised training, unsupervised training, reinforcement learning). Accordingly, in various aspects, the access component can receive, retrieve, or otherwise access a training dataset, and the computerized tool can comprise a training component that can train the first deep learning neural network on the training dataset.

In some instances, the training dataset can include a set of training medical images. In various aspects, a training medical image can be an authentic medical image having the same format, size, or dimensionality as the synthetic medical image discussed above (e.g., if the synthetic medical image is a two-dimensional pixel array, then each training medical image can likewise be a two-dimensional pixel array having the same number or arrangement of pixels as the synthetic medical image; if the synthetic medical image is instead a three-dimensional voxel array, then each training medical image can likewise be a three-dimensional voxel array having the same number or arrangement of voxels as the synthetic medical image).

In various aspects, the training dataset can further include a set of training geometric curves that respectively correspond to the set of training medical images. In various instances, a training geometric curve can be any suitable electronic data having the same format or dimensionality as the geometric curve discussed above (e.g., if the geometric curve discussed above is expressed as a sequence of coordinates in two-space, then each training geometric curve can likewise be expressed as a respective sequence of coordinates in two-space; if the geometric curve discussed above is instead expressed as a three-space parametrized function, then each training geometric curve can likewise be expressed as a respective three-space parametrized function; if the geometric curve discussed above is instead depicted in a two-dimensional image, then each training geometric curve can likewise be depicted in a respective two-dimensional image). In any case, each of the set of training geometric curves (which can have their own respective lengths, shapes, twists, or turns) can be known or deemed to correspond to a respective one of the set of training medical images. In other words, each training medical image can be known or deemed to depict or illustrate one or more anatomical structures whose lengths, shapes, positions, or orientations visually resemble, track, or match those of a respective training geometric curve.

Furthermore, the access component can electronically access, from any suitable source, a second deep learning neural network. In various cases, the second deep learning neural network can exhibit any suitable internal architecture. For example, the second deep learning neural network can include any suitable numbers of any suitable types of layers (e.g., input layer, one or more hidden layers, output layer, any of which can be convolutional layers, dense layers, non-linearity layers, pooling layers, batch normalization layers, or padding layers). As another example, the second deep learning neural network can include any suitable numbers of neurons in various layers (e.g., different layers can have the same or different numbers of neurons as each other). As yet another example, the second deep learning neural network can include any suitable activation functions (e.g., softmax, sigmoid, hyperbolic tangent, rectified linear unit) in various neurons (e.g., different neurons can have the same or different activation functions as each other). As still another example, the second deep learning neural network can include any suitable interneuron connections or interlayer connections (e.g., forward connections, skip connections, recurrent connections). In any case, the second deep learning neural network can be configured to receive as input medical images and to produce as output latent representations of such medical images.

In various aspects, the training component can perform supervised training on the first deep learning neural network, based on the training dataset and based on the second deep learning neural network. Note that, in such cases, the randomized array can have a smaller size, format, or dimensionality than the synthetic medical image. Furthermore, note that, prior to the start of such supervised training, the internal parameters (e.g., weights, biases, convolutional kernels) of the first deep learning neural network and of the second deep learning neural network can be randomly initialized.

During such training, the training component can select from the training dataset any suitable training medical image and any suitable training geometric curve corresponding to such selected training medical image. In various instances, the training component can feed the selected training medical image to the second deep learning neural network, which can cause the second deep learning neural network to produce a first output. For example, the training component can feed the training medical image to an input layer of the second deep learning neural network, the training medical image can complete a forward pass through one or more hidden layers of the second deep learning neural network, and an output layer of the second deep learning neural network can calculate the first output based on activations from the one or more hidden layers of the second deep learning neural network.

Note that, in various cases, the size, format, or dimensionality of the first output can be controlled or otherwise determined by the number or arrangement of neurons in the output layer of the second deep learning neural network (e.g., the first output can be forced to have a desired size, format, or dimensionality, by adding neurons to or removing neurons from the output layer of the second deep learning neural network). Accordingly, in cases in which the second deep learning neural network is implemented, the first output can have the same size, format, or dimensionality as the randomized array discussed above. Thus, because the randomized array can have a smaller size, format, or dimensionality than the synthetic medical image in situations in which the second deep learning neural network is implemented, the first output can likewise have a smaller size, format, or dimensionality than the selected training medical image.

In various aspects, the first output can thus be considered as a predicted or inferred latent representation of the selected training medical image. That is, the first output can be considered as a vector, matrix, or tensor that is dimensionally smaller than the selected training medical image and into which the visual content of the selected training medical image has, in the opinion of the second deep learning neural network, been compressed. Note that, if the second deep learning neural network has so far undergone no or little training, then the first output can be highly inaccurate (e.g., can fail to accurately contain the compressed visual content of the selected training medical image).

In various instances, the training component can iteratively insert noise (e.g., Gaussian noise) into the first output, thereby yielding a second output. Accordingly, the second output can have the same size, format, or dimensionality as the first output (e.g., as the randomized array discussed above). In various cases, the training component can perform noise insertion on the first output for any suitable number of iterations (e.g., can insert any suitable amount of noise into the first output). In various aspects, this can cause the second output to appear or otherwise seem to be completely randomized (e.g., the second output can be the product of applying so much noise to the first output, that the numerical elements of the second output seem as if they had been generated at random). In other words, the second output can be considered as approximating a randomized array.

In various aspects, the training component can concatenate the second output with the selected training geometric curve, and the training component can feed such concatenation to the first deep learning neural network, which can cause the first deep learning neural network to produce a third output. For example, the training component can feed such concatenation to an input layer of the first deep learning neural network, such concatenation can complete a forward pass through one or more hidden layers of the first deep learning neural network, and an output layer of the first deep learning neural network can calculate the third output based on activations from the one or more hidden layers of the first deep learning neural network.

Note that, in various cases and just as above, the size, format, or dimensionality of the third output can be controlled or otherwise determined by the number or arrangement of neurons in the output layer of the first deep learning neural network (e.g., the third output can be forced to have a desired size, format, or dimensionality, by adding neurons to or removing neurons from the output layer of the first deep learning neural network). Accordingly, the third output can have the same size, format, or dimensionality as the selected training medical image.

In various aspects, the third output can thus be considered as a predicted or inferred medical image that the first deep learning neural network has synthesized based on both the second output (e.g., the approximate randomized array) and the selected training geometric curve. In contrast, the selected training medical image can be considered as the correct or accurate medical image that is known or otherwise deemed to correspond to both the second output and the selected training geometric curve. Note that, if the first deep learning neural network has so far undergone no or little training, then the third output can be highly inaccurate (e.g., can be very different from the selected training medical image).

In various aspects, the training component can compute any suitable error or loss (e.g., mean absolute error (MAE), mean squared error (MSE), cross-entropy) between the third output and the selected training medical image. Accordingly, the training component can update the internal parameters (e.g., convolutional kernels, weights, biases) of both the first deep learning neural network and of the second deep learning neural network by performing backpropagation (e.g., stochastic gradient descent) driven by the computed error or loss.

In various instances, such supervised training procedure can be repeated for each training medical image in the training dataset, with the result being that the internal parameters of the second deep learning neural network can become iteratively optimized to accurately generate latent representations of inputted medical images, and with the result also being that the internal parameters of the first deep learning neural network can become iteratively optimized to accurately synthesize realistic-looking medical images based on inputted geometric curves and randomized arrays (where such randomized arrays have smaller sizes, formats, or dimensionalities than such synthesized medical images). In various cases, the training component can implement any suitable training batch sizes, any suitable training termination criteria, or any suitable error, loss, or objective functions when training the first deep learning neural network and the second deep learning neural network in such fashion.

Note that, in cases where the first deep learning neural network is trained with the second deep learning neural network, the second deep learning neural network can be considered as a stable diffusion encoder, and the first deep learning neural network can be considered as a stable diffusion denoiser/decoder.

Now, in various other embodiments, the training component can perform supervised training on the first deep learning neural network based on the training dataset, but without utilizing the second deep learning neural network. Note that, in such cases, the randomized array discussed above can instead have a same size, format, or dimensionality as the synthetic medical image discussed above, rather than a smaller size, format, or dimensionality. Furthermore, note that, prior to the start of such supervised training, the internal parameters (e.g., weights, biases, convolutional kernels) of the first deep learning neural network can be randomly initialized.

During such training, the training component can select from the training dataset any suitable training medical image and any suitable training geometric curve corresponding to such selected training medical image. In various aspects, the training component can iteratively insert noise (e.g., Gaussian noise) into the selected training medical image, thereby yielding a first result. Accordingly, the first result can have the same size, format, or dimensionality as the selected training medical image. In various cases, the training component can perform noise insertion on the selected training medical image for any suitable number of iterations (e.g., can insert any suitable amount of noise into the selected training medical image). In various aspects, this can cause the first result to appear or otherwise seem to be completely randomized (e.g., the first result can be the product of applying so much noise to the selected training medical image, that the first result can seem to be a pixel array or voxel array that has been randomly-generated). In other words, the first result can be considered as approximating a randomized array.

In various aspects, the training component can concatenate the first result with the selected training geometric curve, and the training component can feed such concatenation to the first deep learning neural network, which can cause the first deep learning neural network to produce a second result. For example, the training component can feed such concatenation to an input layer of the first deep learning neural network, such concatenation can complete a forward pass through one or more hidden layers of the first deep learning neural network, and an output layer of the first deep learning neural network can calculate the second result based on activations from the one or more hidden layers of the first deep learning neural network.

Note that, in various cases, the size, format, or dimensionality of the second result can be controlled or otherwise determined by the number or arrangement of neurons in the output layer of the first deep learning neural network (e.g., the second result can be forced to have a desired size, format, or dimensionality, by adding neurons to or removing neurons from the output layer of the first deep learning neural network). Accordingly, the second result can have the same size, format, or dimensionality as the first result and thus as the selected training medical image.

In various aspects, the second result can be considered as a predicted or inferred medical image that the first deep learning neural network has synthesized based on both the first result (e.g., the approximate randomized array) and the selected training geometric curve. In contrast, the selected training medical image can be considered as the correct or accurate medical image that is known or otherwise deemed to correspond to both the first result and the selected training geometric curve. Note that, if the first deep learning neural network has so far undergone no or little training, then the second result can be highly inaccurate (e.g., can be very different from the selected training medical image).

In various aspects, the training component can compute any suitable error or loss (e.g., MAE, MSE, cross-entropy) between the second result and the selected training medical image. Accordingly, the training component can update the internal parameters (e.g., convolutional kernels, weights, biases) of the first deep learning neural network by performing backpropagation (e.g., stochastic gradient descent) driven by the computed error or loss.

As above, such supervised training procedure can be repeated for each training medical image in the training dataset, thereby causing the internal parameters of the first deep learning neural network to become iteratively optimized to accurately synthesize realistic-looking medical images based on inputted geometric curves and randomized arrays (where such synthetic medical images have the same size, format, or dimensionality as such randomized arrays). In various cases, the training component can implement any suitable training batch sizes, any suitable training termination criteria, or any suitable error, loss, or objective functions when training the first deep learning neural network in such fashion.

In any case, the computerized tool described herein can utilize the first deep learning neural network (once trained) to generate synthetic, yet realistic, medical images based on inputted geometric curves. Note that, in various cases, there can be a plurality of geometric curves (e.g., each specified by a user or technician). Accordingly, the computerized tool described herein can be implemented to generate a unique, synthetic-yet-realistic medical image for each of such plurality of geometric curves (e.g., one synthetic medical image per geometric curve), thereby yielding a plurality of synthetic medical images. In various aspects, such plurality of synthetic medical images can be annotated or otherwise treated as a training dataset on which any suitable machine learning model can be trained to perform any suitable inferencing task.

Various embodiments described herein can be employed to use hardware or software to solve problems that are highly technical in nature (e.g., to facilitate curve-conditioned medical image synthesis), that are not abstract and that cannot be performed as a set of mental acts by a human. Further, some of the processes performed can be performed by a specialized computer (e.g., a deep learning neural network having internal parameters such as convolutional kernels) for carrying out defined acts related to curve-conditioned medical image synthesis. For example, such defined acts can include: accessing, by a device operatively coupled to a processor, a user-specified geometric curve; generating, by the device and via execution of a first deep learning neural network on the user-specified geometric curve, a synthetic medical image whose visual characteristics are based on the user-specified geometric curve; and rendering, by the device, the synthetic medical image on an electronic display.

Such defined acts are not performed manually by humans. Indeed, neither the human mind nor a human with pen and paper can electronically obtain a geometric curve, electronically execute a deep learning neural network on the geometric curve so as to synthesize a medical image whose visual characteristics resemble the geometric curve, and electronically render the synthetic medical image on a computer screen. Indeed, a deep learning neural network is an inherently-computerized construct that simply cannot be implemented in any way by the human mind without computers. Similarly, the synthesis of medical images (e.g., of fake images that look as if they had been captured by CT scanners, MRI scanners, X-ray scanners, PET scanners, or ultrasound scanners) is an inherently computerized process that cannot be implemented in any way by the human mind without computers. Accordingly, a computerized tool that can train or execute a deep learning neural network to synthesize medical images based on inputted geometric curves is likewise inherently-computerized and cannot be implemented in any sensible, practical, or reasonable way without computers.

Moreover, various embodiments described herein can integrate into a practical application various teachings relating to curve-conditioned medical image synthesis. As explained above, training of a machine learning model can rely upon having a large volume of available medical images. Due to privacy laws and radiation exposure restrictions, it can be difficult to obtain large amounts of authentic medical images. Accordingly, synthetic medical images, instead of authentic medical images, can be used to train machine learning models. Existing techniques generate synthetic medical images via generative adversarial networks. As explained above, although such existing techniques can synthesize medical images that look realistic, such existing techniques give users or technicians little to no control or influence over the specific visual content of a synthesized medical image.

Various embodiments described herein can address one or more of these technical problems. Specifically, the present inventors devised various embodiments that can facilitate curve-conditioned medical image synthesis. In particular, a deep learning neural network can be trained or otherwise configured as described herein to receive as input a geometric curve and to produce as output a synthetic medical image whose visual content resembles or is otherwise based on the shape, position, or orientation of the geometric curve. Accordingly, a user or technician can specify any suitable geometric curve that they desire, and the deep learning neural network described here can synthesize a medical image that resembles such geometric curve. In other words, various embodiments described herein can allow a user or technician to easily and reliably exercise increased control or influence over the specific visual content of synthesized medical images, as compared to existing techniques. Thus, various embodiments described herein certainly constitute a concrete and tangible technical improvement in the field of medical image synthesis, and such embodiments clearly qualify as useful and practical applications of computers.

Furthermore, various embodiments described herein can control real-world tangible devices based on the disclosed teachings. For example, various embodiments described herein can electronically execute or train real-world deep learning neural networks to synthesize realistic-looking medical images (e.g., artificial images that appear to be the results of CT scans, MRI scans, X-ray scans, PET scans, or ultrasound scans), and can electronically render such synthesized-yet-realistic medical images on real-world computer screens.

It should be appreciated that the herein figures and description provide non-limiting examples of various embodiments and are not necessarily drawn to scale.

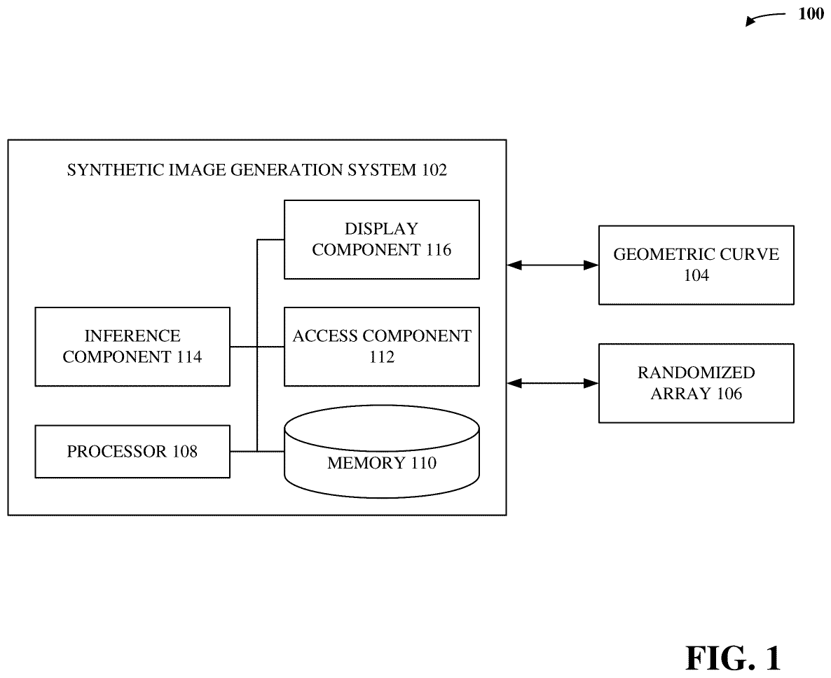

FIG. 1 illustrates a block diagram of an example, non-limiting system 100 that can facilitate curve-conditioned medical image synthesis in accordance with one or more embodiments described herein. As shown, a synthetic image generation system 102 can be electronically integrated, via any suitable wired or wireless electronic connections, with a geometric curve 104 and with a randomized array 106.

In various embodiments, the geometric curve 104 can be a two-dimensional curve. In such case, the geometric curve 104 can be any suitable path that can be traced by a point within a two-dimensional plane. In various other embodiments, the geometric curve 104 can be a three-dimensional curve. In such case, the geometric curve 104 can be any suitable path that can be traced by a point within a three-dimensional space or volume.

Regardless of its dimensionality, the geometric curve 104 can exhibit any suitable geometric characteristics. As a non-limiting example, the geometric curve 104 can exhibit any suitable total length or any suitable shapes. In such case, the geometric curve 104 can have any suitable number of straight segments, each having any suitable respective length or any suitable respective orientation. Likewise, in such case, the geometric curve 104 can have any suitable number of arched segments, each having any suitable respective arc-length, any suitable respective orientation, or any suitable respective radius of curvature. Accordingly, the geometric curve 104 can meander within a two-dimensional plane or within three-dimensional space (as appropriate), thereby forming any suitable numbers of straight-aways, loops, coils, twists, or turns. As another non-limiting example, the geometric curve 104 can exhibit any suitable level of smoothness or non-smoothness. For instance, the geometric curve 104 can be smooth. This can mean that the geometric curve 104 can have no sharp corners or edges, such that the geometric curve 104 can be differentiable along its entire length. Conversely, in various aspects, the geometric curve 104 can be not smooth. This can mean that the geometric curve 104 can, instead, have one or more sharp corners or edges, such that the geometric curve 104 can be not differentiable along its entire length. After all, a curve can be not differential at a sharp corner or edge. As yet another non-limiting example, the geometric curve 104 can exhibit any suitable level of continuity or non-continuity. For instance, the geometric curve 104 can be continuous along its entire length, such that the geometric curve 104 can be considered as being a single, unbroken, contiguous path. In other cases, however, the geometric curve 104 can be non-continuous or otherwise broken, such that the geometric curve 104 can be considered as being made up of two or more separately-contiguous paths.

In various aspects, the geometric curve 104 can be expressed, indicated, or otherwise represented in any suitable electronic data format.

For instance, in some cases, the geometric curve 104 can be expressed as a sequence of coordinates that identify any suitable number of specific points in a two-dimensional plane or in three-dimensional space, as appropriate, where such specific points, when consecutively connected to each other in sequence, can collectively form the geometric curve 104. Such sequence of coordinates can be defined in any suitable coordinate system.

As a non-limiting example, such sequence of points can be defined in a two-dimensional Cartesian coordinate system. In such case, the geometric curve 104 can be expressed or otherwise represented as C={(xᵢ, yᵢ):xᵢ∈X, yᵢ∈Y, and |X|=|Y|}, where C can represent the set of points belonging to the geometric curve 104, where i can represent any suitable positive integer index, where xᵢ can represent an i-th x-coordinate of the geometric curve 104, where yᵢ can represent an i-th y-coordinate of the geometric curve 104, where X can represent the set of all x-coordinate values (e.g., which can include duplicated values) in or along the geometric curve 104, and where Y can represent the set of all y-coordinate values (e.g., which can include duplicated values) in or along the geometric curve 104.

As another non-limiting example, such sequence of points can be defined in a three-dimensional Cartesian coordinate system. In such case, the geometric curve 104 can be expressed or otherwise represented as C={(xᵢ, yᵢ, zᵢ):xᵢ∈X, yᵢ∈Y, zᵢ∈Z, and |X|=|Y|=|Z|}, where C, i, xᵢ, yᵢ, X, and Y can be as described above, where zᵢ can represent an i-th z-coordinate of the geometric curve 104, and where Z can represent the set of all z-coordinate values (e.g., which can include duplicated values) in or along the geometric curve 104.

As still another non-limiting example, such sequence of points can be defined in a two-dimensional polar coordinate system. In such case, the geometric curve 104 can be expressed or otherwise represented as C={(rᵢ, θᵢ):rᵢ∈R, θᵢ∈Θ, and |R|=|Θ|}, where C and i can be as described above, where can represent an i-th radius coordinate of the geometric curve 104, where θᵢ can represent an i-th angular coordinate of the geometric curve 104, where R can represent the set of all radius coordinate values (e.g., which can include duplicated values) in or along the geometric curve 104, and where Θ can represent the set of all angular coordinate values (e.g., which can include duplicated values) in or along the geometric curve 104.

As yet another non-limiting example, such sequence of points can be defined in a three-dimensional cylindrical coordinate system. In such case, the geometric curve 104 can be expressed or otherwise represented as C={(rᵢ, θᵢ, zᵢ):rᵢ∈R, θᵢ∈Θ, zᵢ∈Z, and |R|=|Θ|=|Z|}, where C, i, rᵢ, θᵢ, zᵢ, R, Θ, and Z can be described above.

As even another non-limiting example, such sequence of points can be defined in a three-dimensional spherical coordinate system. In such case, the geometric curve 104 can be expressed or otherwise represented as C={(rᵢ, θᵢ, φᵢ):rᵢ∈R, θᵢ∈Θ, φᵢ∈Φ, and |R|=|Θ|=|Φ|}, where C, i, rᵢ, θᵢ, R, and Θ can be as described above, where φᵢ can represent an i-th ancillary angular coordinate of the geometric curve 104, and where Φ can represent the set of all ancillary angular coordinate values (e.g., which can include duplicated values) in or along the geometric curve 104.

In other cases, the geometric curve 104 can be expressed as any suitable number of parametrized functions that analytically define, based on a parameter argument, a sequence of coordinates in a two-dimensional plane or in three-dimensional space (as appropriate), which, when consecutively connected to each other in sequence, can collectively form the geometric curve 104. Similar to above, such parametrized functions can be expressed in any suitable coordinate system.

As a non-limiting example, such parametrized functions can be expressed in a two-dimensional Cartesian coordinate system, in which case the geometric curve 104 can be given by C={(x(t), y(t)):t∈I}, where C can represent the set of points belonging to the geometric curve 104, where t can be any suitable scalar parameter within any suitable real-number interval I, where x(t) can be any suitable mathematical function comprising any suitable mathematical operators that defines how the x-coordinate of the geometric curve 104 varies with t; and where y(t) can be any suitable mathematical function comprising any suitable mathematical operators that defines how the y-coordinate of the geometric curve 104 varies with t.

As another non-limiting example, such parametrized functions can be expressed in a three-dimensional Cartesian coordinate system, in which case the geometric curve 104 can be given by C={(x(t), y(t), z(t)):t∈I}, where C, t, I, x(t), and y(t) can be as described above, and where z(t) can be any suitable mathematical function comprising any suitable mathematical operators that defines how the z-coordinate of the geometric curve 104 varies with t.

As still another non-limiting example, such parametrized functions can be expressed in a two-dimensional polar coordinate system, in which case the geometric curve 104 can be given by C={(r(t), θ(t)):t∈I}, where C, t, and I can be as described above, where r(t) can be any suitable mathematical function comprising any suitable mathematical operators that defines how the radius coordinate of the geometric curve 104 varies with t; and where θ(t) can be any suitable mathematical function comprising any suitable mathematical operators that defines how the angular coordinate of the geometric curve 104 varies with t.

As yet another non-limiting example, such parametrized functions can be expressed in a three-dimensional cylindrical coordinate system, in which case the geometric curve 104 can be given by C={(r(t), θ(t), z(t)):t∈I}, where C, t, I, r(t), θ(t), and z(t) can be as described above.

As even another non-limiting example, such parametrized functions can be expressed in a three-dimensional spherical coordinate system, in which case the geometric curve 104 can be given by C={(r(t), θ(t), φ(t)):t∈I}, where C, t, I, r(t), and θ(t) can be as described above, and where φ(t) can be any suitable mathematical function comprising any suitable mathematical operators that defines how the ancillary angular coordinate of the geometric curve 104 varies with t.

In yet other cases, the geometric curve 104 can be depicted or illustrated in an image. As a non-limiting example, if the geometric curve 104 is a two-dimensional curve, then the geometric curve 104 can be shown in a g-by-h pixel array for any suitable positive integers g and h, where such pixel array can illustrate nothing other than the geometric curve 104. As another non-limiting example, if the geometric curve 104 is a three-dimensional curve, then the geometric curve 104 can be shown in a g-by-h-by-j voxel array for any suitable positive integers g, h, and j, where such voxel array can illustrate nothing other than the geometric curve 104.

No matter how the geometric curve 104 is electronically or digitally formatted, expressed, or represented, the geometric curve 104 can be specified by a user or technician that is overseeing or operating the synthetic image generation system 102. For example, the user or technician can utilize any suitable human-computer interface device, such as a keyboard, keypad, computer mouse, or touchscreen, to specify or otherwise create the geometric curve 104.

In various embodiments, the randomized array 106 can exhibit any suitable format, size, or dimensionality. As a non-limiting example, the randomized array 106 can be a one-dimensional vector. For instance, the randomized array 106 can be an a-element vector for any suitable positive integer a. In such case, the randomized array 106 can be considered as a row-vector or column-vector having a total of a real-valued or integer-valued scalar elements. As another non-limiting example, the randomized array 106 can be a two-dimensional matrix. For instance, the randomized array 106 can be an a-by-b matrix for any suitable positive integers a and b. In such case, the randomized array 106 can be considered a matrix having a total of ab real-valued or integer-valued scalar elements. As yet another non-limiting example, the randomized array 106 can be a three-dimensional tensor. For instance, the randomized array 106 can be an a-by-b-by-c tensor for any suitable positive integers a, b, and c. In such case, the randomized array 106 can be considered a tensor having a total of abc real-valued or integer-valued scalar elements.

No matter the dimensionality of the randomized array 106, the scalar elements of the randomized array 106 can have randomly-generated magnitudes. In other words, the scalar elements that make up the randomized array 106 can have magnitudes that are randomly sampled from any suitable real-valued or integer-valued interval. In various instances, such interval can be considered as being defined by any suitable low-end threshold value and any suitable high-end threshold value that is greater than the low-end threshold value. In any case, the randomized array 106 can be randomly generated.

In various embodiments, it can be desired to generate a synthetic medical image whose visual characteristics resemble or are otherwise based on the geometric curve 104. In various aspects, as described herein, the synthetic image generation system 102 can facilitate such medical image synthesis.

In various embodiments, the synthetic image generation system 102 can comprise a processor 108 (e.g., computer processing unit, microprocessor) and a non-transitory computer-readable memory 110 that is operably or operatively or communicatively connected or coupled to the processor 108. The non-transitory computer-readable memory 110 can store computer-executable instructions which, upon execution by the processor 108, can cause the processor 108 or other components of the synthetic image generation system 102 (e.g., access component 112, inference component 114, display component 116) to perform one or more acts. In various embodiments, the non-transitory computer-readable memory 110 can store computer-executable components (e.g., access component 112, inference component 114, display component 116), and the processor 108 can execute the computer-executable components.

In various embodiments, the synthetic image generation system 102 can comprise an access component 112. In various aspects, the access component 112 can electronically receive or otherwise electronically access the geometric curve 104 or the randomized array 106. In various instances, the access component 112 can electronically retrieve the geometric curve 104 or the randomized array 106 from any suitable centralized or decentralized data structures (not shown) or from any suitable centralized or decentralized computing devices (not shown). As a non-limiting example, the access component 112 can retrieve the geometric curve 104 from whatever human-computer interface device was implemented to allow the user or technician overseeing the synthetic image generation system 102 to specify the geometric curve 104, and the access component 112 can itself generate the randomized array 106. In any case, the access component 112 can electronically obtain or access the geometric curve 104 or the randomized array 106, such that other components of the synthetic image generation system 102 can electronically interact with the geometric curve 104 or with the randomized array 106.

In various embodiments, the synthetic image generation system 102 can comprise an inference component 114. In various aspects, as described herein, the inference component 114 can execute a deep learning neural network on both the geometric curve 104 and the randomized array 106, thereby yielding a synthetic medical image whose visual content resembles the geometric curve 104.

In various embodiments, the synthetic image generation system 102 can comprise a display component 116. In various instances, as described herein, the display component 116 can electronically render the synthetic medical image on any suitable electronic display.

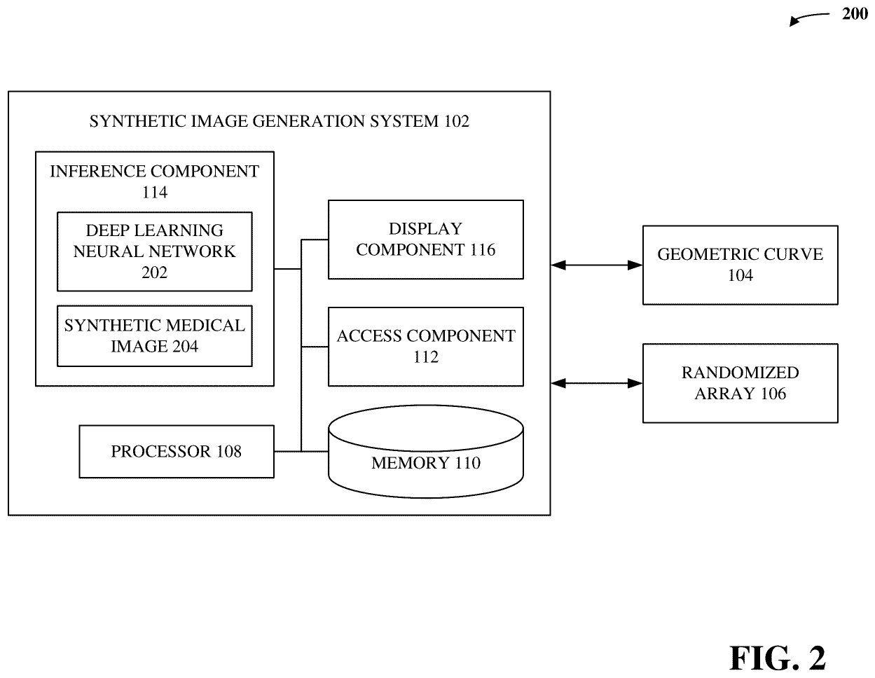

FIG. 2 illustrates a block diagram of an example, non-limiting system 200 including a deep learning network and a synthetic medical image that can facilitate curve-conditioned medical image synthesis in accordance with one or more embodiments described herein. As shown, the system 200 can, in some cases, comprise the same components as the system 100, and can further comprise a deep learning neural network 202 and a synthetic medical image 204.

In various embodiments, the inference component 114 can electronically store, electronically maintain, electronically control, or otherwise electronically access the deep learning neural network 202. In various aspects, the deep learning neural network 202 can have or otherwise exhibit any suitable internal architecture. For instance, the deep learning neural network 202 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable internal parameters can be weight matrices or bias values. As still another example, any of such input layer, one or more hidden layers, or output layer can be batch normalization layers, whose learnable or trainable internal parameters can be shift factors or scale factors. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

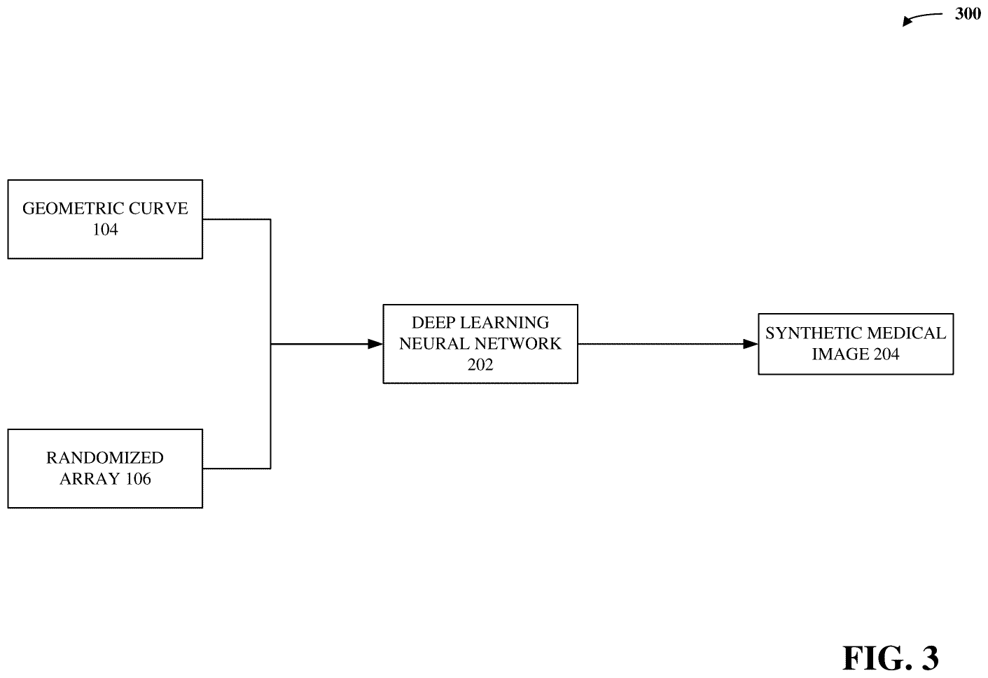

In various aspects, the inference component 114 can electronically execute the deep learning neural network 202 on the geometric curve 104 and on the randomized array 106, and such execution can cause the deep learning neural network 202 to produce the synthetic medical image 204. Various non-limiting aspects are further described with respect to FIGS. 3-5.

FIGS. 3-5 illustrate example, non-limiting block diagrams 300, 400, and 500 showing how the deep learning neural network 202 can generate the synthetic medical image 204 based on the geometric curve 104 in accordance with one or more embodiments described herein.

First, consider FIG. 3. In various aspects, as shown, the inference component 114 can feed the geometric curve 104 and the randomized array 106 as input to the deep learning neural network 202. In response, the deep learning neural network 202 can generate the synthetic medical image 204. More specifically, the inference component 114 can, in some cases, concatenate the geometric curve 104 with the randomized array 106 and can feed such concatenation to an input layer of the deep learning neural network 202. In other cases, however, the inference component 114 can feed the randomized array 106 to the input layer of the deep learning neural network 202, and the inference component 114 can feed the geometric curve 104 to a conditioning layer of the deep learning neural network 202, such as a feature-wise linear modulation layer (e.g., FiLM). In either case, both the geometric curve 104 and the randomized array 106 can complete a forward pass through one or more hidden layers of the deep learning neural network 202. In various instances, an output layer of the deep learning neural network 202 can compute or otherwise calculate the synthetic medical image 204, based on activation maps produced by the one or more hidden layers of the deep learning neural network 202.

In various aspects, the synthetic medical image 204 can be an image that exhibits any suitable size, format, or dimensionality. As a non-limiting example, the synthetic medical image 204 can be a two-dimensional array of pixels. As another non-limiting example, the synthetic medical image 204 can be a three-dimensional array of voxels.

In various instances, the synthetic medical image 204 can exhibit the same size, format, or dimensionality as the randomized array 106. As a non-limiting example, suppose that the randomized array 106 is an a-by-b matrix for any suitable positive integers a and b. In such case, the synthetic medical image 204 can be an a-by-b array of pixels. As another non-limiting example, suppose that the randomized array 106 is an a-by-b-by-c tensor for any suitable positive integers a, b, and c. In such case, the synthetic medical image 204 can be an a-by-b-by-c array of voxels.

However, in various other instances, the synthetic medical image 204 can have a larger size, format, or dimensionality than the randomized array 106. As a non-limiting example, suppose that the randomized array 106 is an a-element vector, for any suitable positive integer a. In some of such cases, the synthetic medical image 204 can be an a*-by-b array of pixels, for any suitable positive integer b and for any suitable positive integer a*≥aIn other of such cases, the synthetic medical image 204 can be an a*-by-b-by-c array of voxels, for any suitable positive integers b and c and for any suitable positive integer a*≥aAs another non-limiting example, suppose that the randomized array 106 is an a-by-b matrix, for any suitable positive integers a and b. In some of such cases, the synthetic medical image 204 can be an a*-by-b* array of pixels, for any suitable positive integers a*≥a and b*>b, or for any suitable positive integers a*>a and b*≥b. In other of such cases, the synthetic medical image 204 can be an a*-by-b*-by-c array of voxels, for any suitable positive integer c and for any suitable positive integers a*≥a and b*≥b. As still another non-limiting example, suppose that the randomized array 106 is an a-by-b-by-c tensor. In some of such cases, the synthetic medical image 204 can be an a*-by-b*-by-c* array of voxels for: any suitable positive integers a*>a, b*≥b, and c*≥c; any suitable positive integers a*≥a, b*>b, and c*≥c; or any suitable positive integers a*≥a, b*≥b, and c*>c.

In any case, the synthetic medical image 204 can visually appear to be or otherwise look like an authentic (e.g., realistic) medical image. In other words, the synthetic medical image 204 can illustrate or otherwise depict what appear to be one or more anatomical structures, as if such one or more anatomical structures had been captured by medical imaging equipment. As a non-limiting example, the synthetic medical image 204 can visually appear to be a CT scanned image of such one or more anatomical structures. As another non-limiting example, the synthetic medical image 204 can visually appear to be an MRI scanned image of such one or more anatomical structures. As yet another non-limiting example, the synthetic medical image 204 can visually appear to be a PET scanned image of such one or more anatomical structures. As even another non-limiting example, the synthetic medical image 204 can visually appear to be an X-ray scanned image of such one or more anatomical structures. As still another non-limiting example, the synthetic medical image 204 can visually appear to be an ultrasound scanned image of such one or more anatomical structures. Accordingly, the synthetic medical image 204 can visually appear to be a realistic-looking medical image. However, because the synthetic medical image 204 can be generated by the deep learning neural network 202 based on the geometric curve 104 and the randomized array 106, the synthetic medical image 204 cannot depict any portion of an actual, real-world medical patient (hence the term “synthetic”).

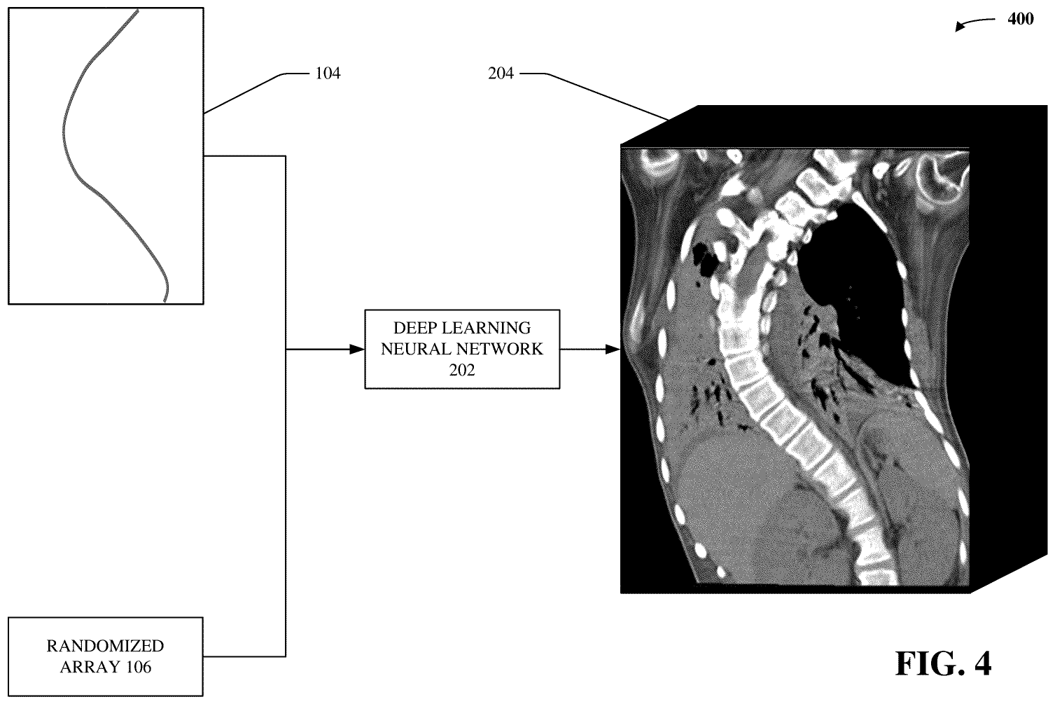

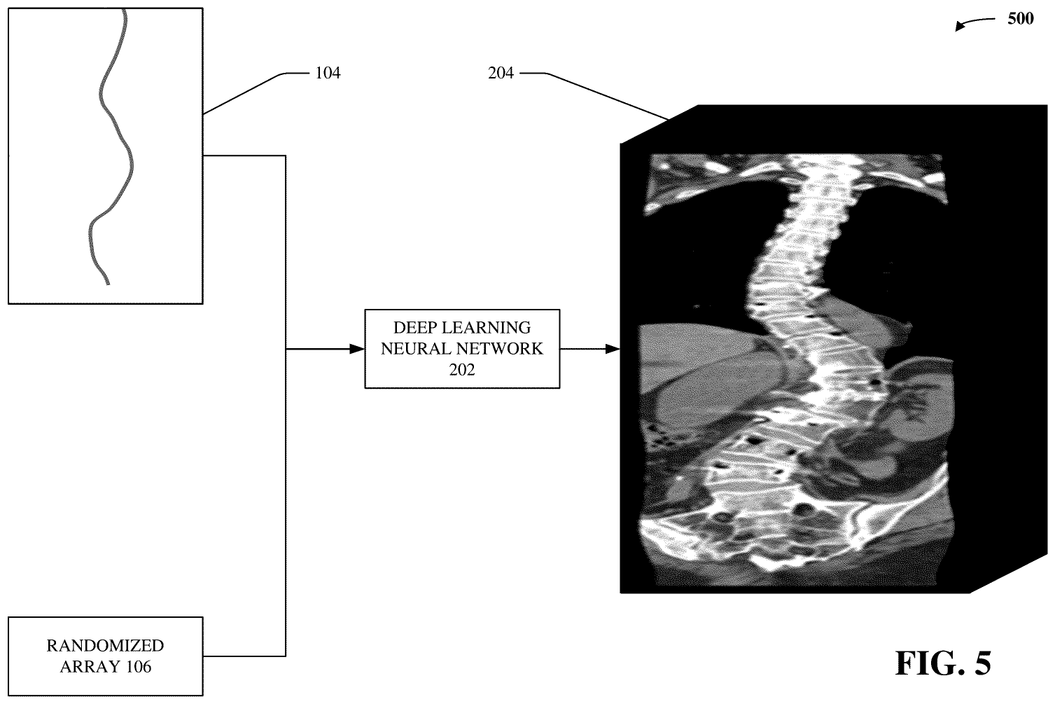

Regardless of the type of medical imaging modality by which the synthetic medical image 204 appears to have been captured, the one or more anatomical structures illustrated in the synthetic medical image 204 can visually resemble or otherwise be structurally or geometrically based on the geometric curve 104. In other words, one or more lengths, one or more shapes, one or more positions, or one or more orientations of the one or more anatomical structures can match, mirror, track, or otherwise follow those of the geometric curve 104. Non-limiting examples created during various experiments conducted by the present inventors are shown with respect to FIGS. 4-5.

First, consider FIG. 4. As shown, FIG. 4 indicates a non-limiting example embodiment of the geometric curve 104 and a corresponding non-limiting example embodiment of the synthetic medical image 204. As can be seen in FIG. 4, the geometric curve 104 can be a two-dimensional curve that extends substantially vertically, whose two end-portions have slightly rightward positions, and whose middle-portion substantially lobes out leftward. As can also be seen in FIG. 4, the synthetic medical image 204 can be a three-dimensional voxel array (of which a single slice is shown in FIG. 4 for ease of illustration) that depicts what appears to be a realistic-looking spinal column whose shape resembles that of the geometric curve 104. Indeed, as shown, the spinal column in FIG. 4 extends substantially vertically, has a top-end and a bottom-end that have slightly rightward positions, and has a middle-portion that lobes out leftward.

Next, consider FIG. 5. As shown, FIG. 5 indicates another non-limiting example embodiment of the geometric curve 104 and another corresponding non-limiting example embodiment of the synthetic medical image 204. As can be seen in FIG. 5, the geometric curve 104 can be a two-dimensional curve that extends substantially vertically, whose two end-portions are centrally positioned, and whose middle-portion exhibits an undulating shape with two leftward lobes and one rightward lobe. As can also be seen in FIG. 5, the synthetic medical image 204 can be a three-dimensional voxel array (of which a single slice is shown in FIG. 5 for ease of illustration) that depicts what appears to be a realistic-looking spinal column whose shape resembles that of the geometric curve 104. Indeed, as shown, the spinal column in FIG. 5 extends substantially vertically, has a top-end and a bottom-end that have central positions, and has a middle-portion that undulates with two leftward lobes and one rightward lobe.

As the non-limiting examples of FIGS. 4-5 help to illustrate, the visual content of the synthetic medical image 204 (e.g., the lengths, shapes, positions, or orientations of the one or more putative anatomical structures illustrated in the synthetic medical image 204) can resemble or otherwise be based on the geometric curve 104. Accordingly, the user or technician that specifies the geometric curve 104 can be considered as having an increased degree of control or influence over the visual content of the synthetic medical image 204 (e.g., the user or technician can cause the synthetic medical image 204 to depict one or more anatomical structures having a desired shape, by specifying the geometric curve 104 to have that desired shape).

In various embodiments, the display component 116 can electronically render, on any suitable electronic display (e.g., any suitable computer screen, any suitable computer monitor, any suitable graphical user-interface), the synthetic medical image 204. In various other aspects, the display component 116 can electronically transmit the synthetic medical image 204 to any suitable computing device (not shown).

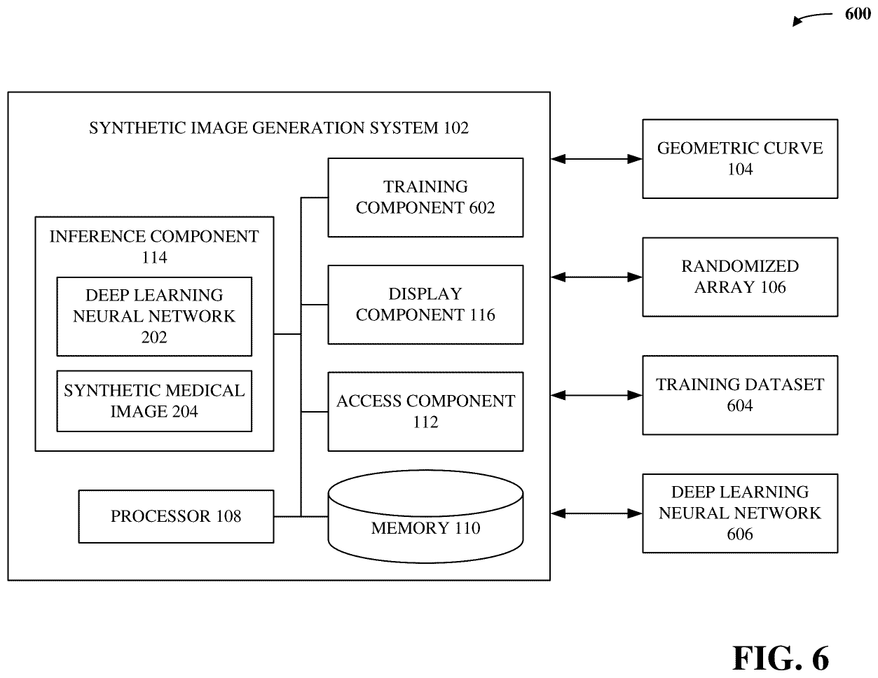

To help ensure that the synthetic medical image 204 is realistic, the deep learning neural network 202 can first undergo training. Various non-limiting aspects of such training are described with respect to FIGS. 6-9.

FIG. 6 illustrates a block diagram of an example, non-limiting system 600 including a training component, a training dataset, and another deep learning neural network that can facilitate curve-conditioned medical image synthesis in accordance with one or more embodiments described herein. As shown, the system 600 can, in some cases, comprise the same components as the system 200, and can further comprise a training component 602, a training dataset 604, or a deep learning neural network 606.

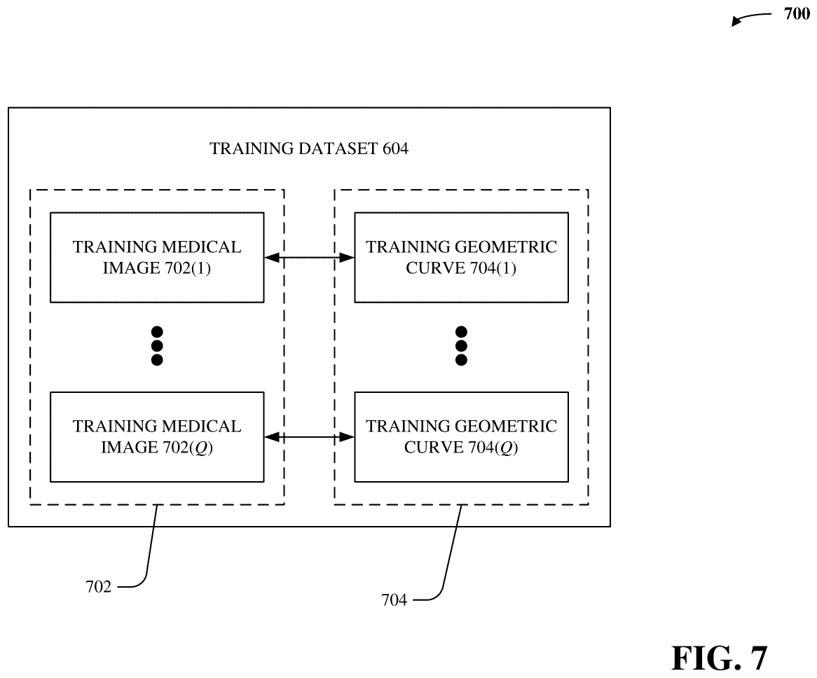

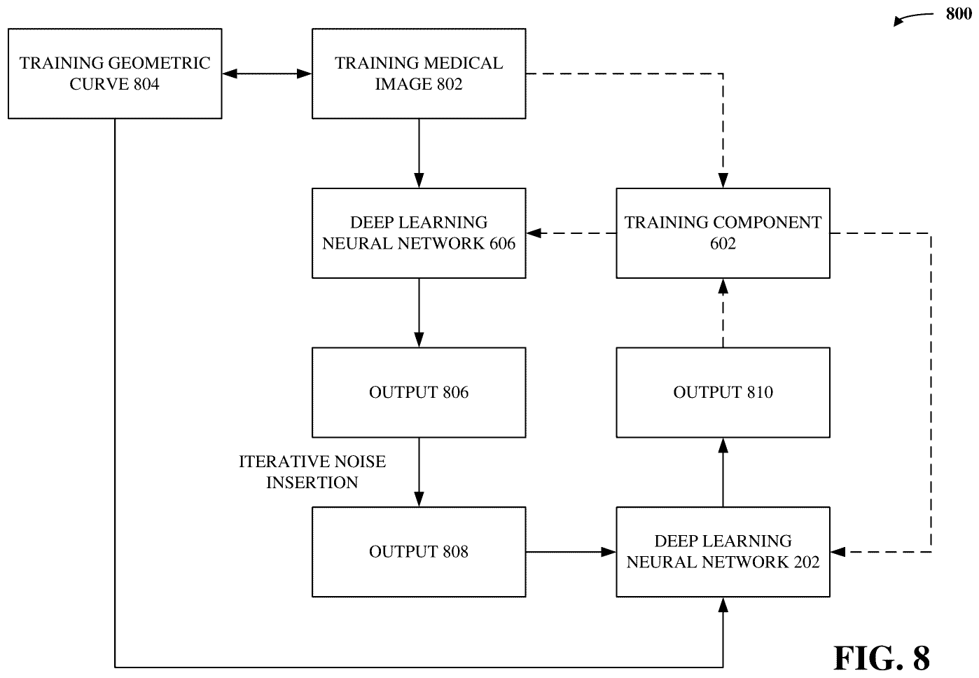

In various embodiments, the access component 112 can electronically receive, retrieve, obtain, or otherwise access, from any suitable sources, the training dataset 604 or the deep learning neural network 606. In various aspects, the training component 602 can train the deep learning neural network 202, based on both the training dataset 604 and the deep learning neural network 606, as described with respect to FIGS. 7 and 8.

First, consider FIG. 7. FIG. 7 illustrates an example, non-limiting block diagram 700 of the training dataset 604 in accordance with one or more embodiments described herein.

As shown, the training dataset 604 can, in various aspects, comprise a set of training medical images 702. In various instances, the set of training medical images 702 can comprise q images for any suitable positive integer q: a training medical image 702(1) to a training medical image 702(q). In various cases, a training medical image can be any suitable authentic medical image that exhibits the same size, format, or dimensionality as the synthetic medical image 204. As a non-limiting example, suppose that the synthetic medical image 204 is a two-dimensional pixel array. In such case, each of the set of training medical images 702 can be a two-dimensional pixel array that was generated or captured by a respective medical imaging modality (e.g., a CT scanner, an MRI scanner, a PET scanner, an X-ray scanner, an ultrasound scanner) and that has the same number of pixel columns and pixel rows as the synthetic medical image 204. As another non-limiting example, suppose that the synthetic medical image 204 is instead a three-dimensional voxel array. In such case, each of the set of training medical images 702 can be a three-dimensional voxel array that was generated or captured by a respective medical imaging modality (e.g., a CT scanner, an MRI scanner, a PET scanner, an X-ray scanner, an ultrasound scanner) and that has the same number of voxel columns, voxel rows, and voxel layers as the synthetic medical image 204.

In various aspects, the training dataset 604 can further comprise a set of training geometric curves 704. In various instances, the set of training geometric curves 704 can respectively correspond (e.g., in one-to-one fashion) with the set of training medical images 702. Accordingly, since the set of training medical images 702 can comprise q images, the set of training geometric curves 704 can comprise q curves: a training geometric curve 704(1) to a training geometric curve 704(q). In various cases, each of the set of training geometric curves 704 can be a curve expressed via the same electronic format or dimensionality as the geometric curve 104. As a non-limiting example, suppose that the geometric curve 104 is a path defined as a sequence of coordinates in a two-dimensional Cartesian plane. In such case, each of the set of training geometric curves 704 can likewise be a path defined by a respective sequence of coordinates in a two-dimensional Cartesian plane. As another non-limiting example, suppose that the geometric curve 104 is a path defined by one or more parametric functions in three-dimensional spherical space. In such case, each of the set of training geometric curves 704 can likewise be a path defined by one or more respective parametric functions in three-dimensional spherical space. As yet another non-limiting example, suppose that the geometric curve 104 is a path depicted in a g-by-h-by-j voxel array. In such case, each of the set of training geometric curves 704 can likewise be a path depicted in a respective g-by-h-by-j voxel array. Note that any of the set of training geometric curves 704 can have or otherwise exhibit the same or different geometric properties or characteristics (e.g., length, shapes, radii of curvature, smoothness, continuity) as the geometric curve 104.

In any case, each of the set of training geometric curves 704 can be considered as being known or deemed to geometrically or structurally correspond to a respective one of the set of training medical images 702. As a non-limiting example, the training medical image 702(1) can correspond to the training geometric curve 704(1). Accordingly, the training medical image 702(1) can be an authentic medical image that is known or otherwise deemed to depict one or more anatomical structures whose lengths, shapes, positions, or orientations visually resemble those of the training geometric curve 704(1). As another non-limiting example, the training medical image 702(q) can correspond to the training geometric curve 704(q). Thus, the training medical image 702(q) can be an authentic medical image that is known or otherwise deemed to depict one or more anatomical structures whose lengths, shapes, positions, or orientations visually resemble those of the training geometric curve 704(q).

In various aspects, the deep learning neural network 606 can have or otherwise exhibit any suitable internal architecture. For instance, the deep learning neural network 606 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable internal parameters can be convolutional kernels. As another example, any of such input layer, one or more hidden layers, or output layer can be dense layers, whose learnable or trainable internal parameters can be weight matrices or bias values. As still another example, any of such input layer, one or more hidden layers, or output layer can be batch normalization layers, whose learnable or trainable internal parameters can be shift factors or scale factors. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers. In any case, the deep learning neural network 606 can be configured to produce latent representations (e.g., compressed versions) of inputted medical images.

Now, consider FIG. 8. FIG. 8 illustrates an example, non-limiting block diagram 800 showing how the deep learning neural network 202 can be trained in series with the deep learning neural network 606 based on the training dataset 604 in accordance with one or more embodiments described herein. Note that, in cases where the deep learning neural network 202 is trained in series (e.g., in a stable diffusion pipeline) with the deep learning neural network 606, the randomized array 106 can have a smaller size, format, or dimensionality than the synthetic medical image 204.

In various aspects, the training component 602 can, prior to beginning to train the deep learning neural network 202, initialize in any suitable fashion (e.g., random initialization) the trainable internal parameters (e.g., convolutional kernels, weight matrices, bias values) of the deep learning neural network 202 and of the deep learning neural network 606.

In various instances, the training component 602 can select, from the training dataset 604, a training medical image 802 and a training geometric curve 804 that corresponds to the training medical image 802. In various cases, as shown, the training component 602 can execute the deep learning neural network 606 on the training medical image 802, thereby causing the deep learning neural network 606 to produce an output 806. More specifically, the training component 602 can feed the training medical image 802 to an input layer of the deep learning neural network 606, the training medical image 802 can complete a forward pass through one or more hidden layers of the deep learning neural network 606, and an output layer of the deep learning neural network 606 can compute the output 806 based on activation maps generated by the one or more hidden layers of the deep learning neural network 606.

Note that, in various cases, the size, format, or dimensionality of the output 806 can be controlled or otherwise determined by the number or arrangement of neurons (or by the characteristics of other internal parameters such as convolutional kernels) that are in the output layer of the deep learning neural network 606. That is, the output 806 can be forced to have a desired size, format, or dimensionality (e.g., a desired number or arrangement of numerical elements), by controllably adding or removing neurons to or from (or by otherwise controllably altering characteristics of convolutional kernels or other internal parameters of) the output layer of the deep learning neural network 606.

In various aspects, the output 806 can have a same size, format, or dimensionality as the randomized array 106 (e.g., if the randomized array 106 is an a-element vector, then the output 806 can likewise be an a-element vector; if the randomized array 106 is an a-by-b matrix, then the output 806 can likewise be an a-by-b matrix; if the randomized array 106 is an a-by-b-by-c tensor, then the output 806 can likewise ben an a-by-b-by-c tensor). Note that, as mentioned above, the training medical image 802 can have the same size, format, or dimensionality as the synthetic medical image 204. Also, note that, as mentioned above, the randomized array 106 can have a smaller size, format, or dimensionality than the synthetic medical image 204, in cases where the deep learning neural network 202 is trained in series with the deep learning neural network 606. Accordingly, in the non-limiting embodiment of FIG. 8, the output 806 can have a smaller size, format, or dimensionality than the training medical image 802. In other words, the output 806 can be considered as a predicted or inferred latent representation (e.g., a predicted or inferred compressed version) of the training medical image 802. Note that, if the deep learning neural network 606 has so far undergone no or little training, then the output 806 can be highly inaccurate (e.g., can fail to properly contain compressed versions of the visual content of the training medical image 802).

In various instances, the training component 602 can iteratively insert noise (e.g., Gaussian noise) into the output 806. Such noise insertion can yield an output 808. Thus, the output 808 can have the same size, format, or dimensionality as the output 806 (e.g., if the output 806 is an a-element vector, then the output 808 can likewise be an a-element vector; if the output 806 is an a-by-b matrix, then the output 808 can likewise be an a-by-b matrix; if the output 806 is an a-by-b-by-c tensor, then the output 808 can likewise ben an a-by-b-by-c tensor). In various aspects, the training component 602 can insert any suitable amount of noise into the output 806, such that the output 808 can be considered as approximating a randomized array. In other words, so much noise can be added to the output 806, such that magnitudes of the numerical elements of the output 808 can be considered as having been generated at random.

In various aspects, as shown, the training component 602 can execute the deep learning neural network 202 on both the output 808 (e.g., which can be considered as a pseudo-randomized array) and the training geometric curve 804, thereby causing the deep learning neural network 202 to produce an output 810. More specifically, the training component 602 can feed both the output 808 and the training geometric curve 804 to an input layer (or a conditioning layer, such as FiLM) of the deep learning neural network 202, the output 808 and the training geometric curve 804 can complete a forward pass through one or more hidden layers of the deep learning neural network 202, and an output layer of the deep learning neural network 202 can compute the output 810 based on activation maps generated by the one or more hidden layers of the deep learning neural network 202.

As above, note that, in various cases, the size, format, or dimensionality of the output 810 can be controlled or otherwise determined by the number or arrangement of neurons (or by the characteristics of other internal parameters such as convolutional kernels) that are in the output layer of the deep learning neural network 202. So, the output 810 can be forced to have a desired size, format, or dimensionality (e.g., a desired number or arrangement of numerical elements), by controllably adding or removing neurons to or from (or by otherwise controllably altering characteristics of convolutional kernels or other internal parameters of) the output layer of the deep learning neural network 202.

In various aspects, the output 810 can have the same size, format, or dimensionality as the synthetic medical image 204, and thus as the training medical image 802. In other words, the output 810 can be considered as a predicted or inferred medical image that the deep learning neural network 202 believes should correspond to the output 808 and to the training geometric curve 804. In contrast, the training medical image 802 can be considered as the ground-truth medical image that is known or otherwise deemed to correspond to both the output 808 and to the training geometric curve 804. As above, note that, if the deep learning neural network 202 has so far undergone no or little training, then the output 810 can be highly inaccurate (e.g., can be very different from the training medical image 802).

In any case, the training component 602 can compute at least one error or loss (e.g., MAE, MSE, cross-entropy) between the output 810 and the training medical image 802. In various aspects, the training component 602 can incrementally update, via backpropagation, the trainable internal parameters (e.g., convolutional kernels, weights, biases) of both the deep learning neural network 202 and of the deep learning neural network 606, based on such at least one computed error or loss.

In various aspects, the training component 602 can repeat such execution and update procedure for each training medical image in the training dataset 604. This can ultimately cause the trainable internal parameters of the deep learning neural network 606 to become iteratively optimized for accurately generating latent representations of inputted medical images. Additionally, this can also ultimately cause the trainable internal parameters of the deep learning neural network 202 to become iteratively optimized for synthesizing realistic-looking medical images based on inputted randomized arrays and inputted geometric curves. In various instances, the training component 602 can implement any suitable training batch sizes, any suitable training termination criteria, or any suitable error/loss functions when training the deep learning neural network 202 and the deep learning neural network 606.

Note that, in situations where the deep learning neural network 202 is trained in series with the deep learning neural network 606 as shown in FIG. 8, the deep learning neural network 606 can be considered as a stable diffusion encoder, and the deep learning neural network 202 can be considered as a stable diffusion denoiser and decoder.

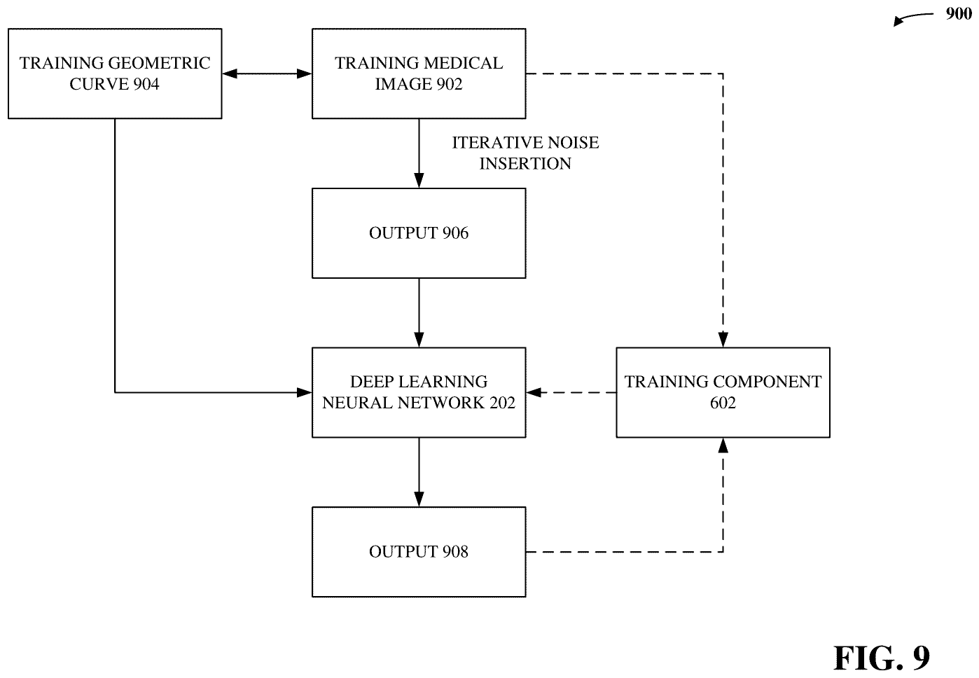

Although FIG. 8 shows that the deep learning neural network 202 can be trained in series with the deep learning neural network 606, this is a mere non-limiting example. In some cases, the deep learning neural network 202 can be trained without the deep learning neural network 606. Various non-limiting aspects are discussed with respect to FIG. 9.

FIG. 9 illustrates an example, non-limiting block diagram 900 showing how the deep learning neural network 202 can be trained without the deep learning neural network 606 in accordance with one or more embodiments described herein. Note that, in cases where the deep learning neural network 202 is trained without the deep learning neural network 606, the randomized array 106 can have a same (not smaller) size, format, or dimensionality as the synthetic medical image 204.

In various aspects, the training component 602 can, prior to beginning to train the deep learning neural network 202, initialize in any suitable fashion (e.g., random initialization) the trainable internal parameters (e.g., convolutional kernels, weight matrices, bias values) of the deep learning neural network 202.

In various instances, the training component 602 can select, from the training dataset 604, a training medical image 902 and a training geometric curve 904 that corresponds to the training medical image 902.

In various instances, the training component 602 can iteratively insert noise (e.g., Gaussian noise) into the training medical image 902. Such noise insertion can yield an output 906. In various aspects, the output 906 can have the same size, format, or dimensionality as the randomized array 106. Note that, as mentioned above, the training medical image 902 can have the same size, format, or dimensionality as the synthetic medical image 204. Also, note that, as mentioned above, the randomized array 106 can have a same (not smaller) size, format, or dimensionality as the synthetic medical image 204, in cases where the deep learning neural network 202 is trained without the deep learning neural network 606. Accordingly, in the non-limiting embodiment of FIG. 9, the output 906 can have a same size, format, or dimensionality as the training medical image 902 (e.g., if the training medical image 902 is two-dimensional pixel array, then the output 906 can be a two-dimensional matrix having the same number of rows and columns as the training medical image 902; if the training medical image 902 is instead a three-dimensional voxel array, then the output 906 can be a three-dimensional tensor having the same number of rows, columns, and layers as the training medical image 902).

In various aspects, the training component 602 can insert any suitable amount of noise into the training medical image 902, such that the output 906 can be considered as approximating a randomized array. In other words, so much noise can be added to the training medical image 902, such that magnitudes of the numerical elements of the output 906 can be considered as having been generated at random.

In various aspects, as shown, the training component 602 can execute the deep learning neural network 202 on both the output 906 (e.g., which can be considered as a pseudo-randomized array) and the training geometric curve 904, thereby causing the deep learning neural network 202 to produce an output 908. More specifically, the training component 602 can feed both the output 906 and the training geometric curve 904 to an input layer (or a conditioning layer, such as FiLM) of the deep learning neural network 202, the output 906 and the training geometric curve 904 can complete a forward pass through one or more hidden layers of the deep learning neural network 202, and an output layer of the deep learning neural network 202 can compute the output 908 based on activation maps generated by the one or more hidden layers of the deep learning neural network 202.

As above, note that, in various cases, the size, format, or dimensionality of the output 908 can be controlled or otherwise determined by the number or arrangement of neurons (or by the characteristics of other internal parameters such as convolutional kernels) that are in the output layer of the deep learning neural network 202. Accordingly, the output 908 can be forced to have a desired size, format, or dimensionality (e.g., a desired number or arrangement of numerical elements), by controllably adding or removing neurons to or from (or by otherwise controllably altering characteristics of convolutional kernels or other internal parameters of) the output layer of the deep learning neural network 202.

In various aspects, the output 908 can have the same size, format, or dimensionality as the synthetic medical image 204, and thus as the output 906 and as the training medical image 902. In other words, the output 908 can be considered as a predicted or inferred medical image that the deep learning neural network 202 believes should correspond to the output 906 and to the training geometric curve 904. In contrast, the training medical image 902 can be considered as the ground-truth medical image that is known or otherwise deemed to correspond to both the output 906 and to the training geometric curve 904. As above, note that, if the deep learning neural network 202 has so far undergone no or little training, then the output 908 can be highly inaccurate (e.g., can be very different from the training medical image 902).

In any case, the training component 602 can compute at least one error or loss (e.g., MAE, MSE, cross-entropy) between the output 908 and the training medical image 902. In various aspects, the training component 602 can incrementally update, via backpropagation, the trainable internal parameters (e.g., convolutional kernels, weights, biases) of the deep learning neural network 202, based on such at least one computed error or loss.

In various aspects, the training component 602 can repeat such execution and update procedure for each training medical image in the training dataset 604. This can ultimately cause the trainable internal parameters of the deep learning neural network 202 to become iteratively optimized for synthesizing realistic-looking medical images based on inputted randomized arrays and inputted geometric curves. In various instances, the training component 602 can implement any suitable training batch sizes, any suitable training termination criteria, or any suitable error/loss functions when training the deep learning neural network 202.

Regardless of whether the deep learning neural network 202 is trained in accordance with FIG. 8 or instead in accordance with FIG. 9, the deep learning neural network 202 can be considered as learning how to synthesize realistic-looking medical images based on inputted randomized arrays and based on inputted geometric curves.

Although the herein disclosure mainly describes various embodiments of the deep learning neural network 202 as generating the synthetic medical image 204 based on the geometric curve 104, this is a mere non-limiting example. In various embodiments, any other suitable user-specified conditionings can accompany (e.g., can be concatenated with) the geometric curve 104. As a non-limiting example, any suitable snippet of text (e.g., character strings) can be concatenated with the geometric curve 104, and the visual content of the synthetic medical image 204 can somehow be based upon the words written in such snippet of text (e.g., such snippet of text can specify whether it is desired for the anatomical structures shown in the synthetic medical image 204 to be “high resolution” or to instead be “low resolution”). As another non-limiting example, any suitable sketch (e.g., rough, hand-drawn, cartoon-like image) can be concatenated with the geometric curve 104, and the visual content of the synthetic medical image 204 can somehow be based upon such sketch (e.g., such sketch can depict various structures or features that are desired to be illustrated in the synthetic medical image 204). In cases where such other conditionings accompany the geometric curve 104, analogous training versions of such other conditionings can be included in the training dataset 604 (e.g., the training dataset 604 can include a set of training texts that respectively correspond to the set of training medical images 702; the training dataset 604 can include a set of training sketches that respectively correspond to the set of training medical images 702).

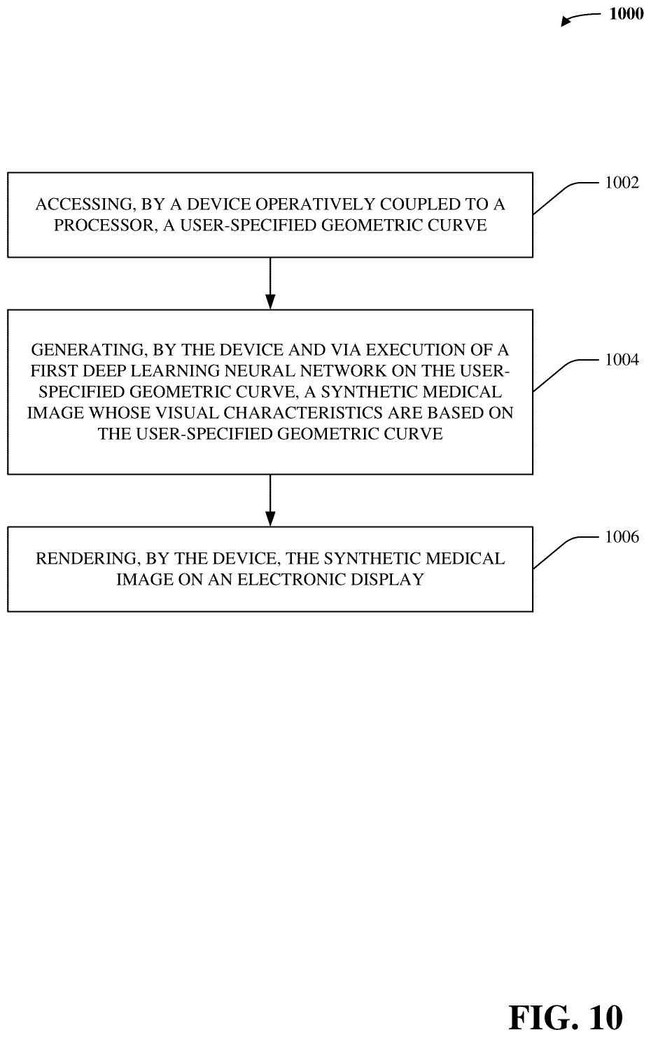

FIG. 10 illustrates a flow diagram of an example, non-limiting computer-implemented method 1000 that can facilitate curve-conditioned medical image synthesis in accordance with one or more embodiments described herein. In various cases, the synthetic image generation system 102 can facilitate the computer-implemented method 1000.

In various embodiments, act 1002 can include accessing, by a device (e.g., via 112) operatively coupled to a processor (e.g., 108), a user-specified geometric curve (e.g., 104).

In various aspects, act 1004 can include generating, by the device (e.g., via 114) and via execution of a first deep learning neural network (e.g., 202) on the user-specified geometric curve, a synthetic medical image (e.g., 204) whose visual characteristics are based on the user-specified geometric curve.

In various instances, act 1006 can include rendering, by the device (e.g., via 116), the synthetic medical image on an electronic display.

Although not explicitly shown in FIG. 10, the first deep learning neural network can receive as input the user-specified geometric curve concatenated with a randomly-generated array (e.g., 106), and the first deep learning neural network can produce as output the synthetic medical image (e.g., as shown in FIGS. 3-5).

Although not explicitly shown in FIG. 10, the user-specified geometric curve can be further concatenated with a text conditioning or a sketch conditioning.

Although not explicitly shown in FIG. 10, the user-specified geometric curve can be a two-dimensional curve or a three-dimensional curve.

Although not explicitly shown in FIG. 10, the computer-implemented method 1000 can comprise accessing, by the device (e.g., via 112), a training dataset (e.g., 604); and training, by the device (e.g., via 602), the first deep learning neural network based on the training dataset.

Although not explicitly shown in FIG. 10, the training dataset can comprise a set of training medical images (e.g., 702) and a set of training geometric curves (e.g., 704) respectively corresponding to the set of training medical images, and the training can comprise: selecting, by the device (e.g., via 602) and from the training dataset, a training medical image (e.g., 902) and a training geometric curve (e.g., 904) that corresponds to the training medical image; iteratively applying, by the device (e.g., via 602), noise to the training medical image, thereby yielding a first output (e.g., 906); executing, by the device (e.g., via 602), the first deep learning neural network on the first output and on the training geometric curve, thereby yielding a second output (e.g., 908); and updating, by the device (e.g., via 602), internal parameters of the first deep learning neural network, via backpropagation based on an error between the second output and the training medical image.

Although not explicitly shown in FIG. 10, the training dataset can comprise a set of training medical images (e.g., 702) and a set of training geometric curves (e.g., 704) respectively corresponding to the set of training medical images, and the training can comprise: selecting, by the device (e.g., via 602) and from the training dataset, a training medical image (e.g., 802) and a training geometric curve (e.g., 804) that corresponds to the training medical image; executing, by the device (e.g., via 602), a second deep learning neural network (e.g., 606) on the training medical image, thereby yielding a first output (e.g., 806); iteratively applying, by the device (e.g., via 602), noise to the first output, thereby yielding a second output (e.g., 808); executing, by the device (e.g., via 602), the first deep learning neural network on the second output and on the training geometric curve, thereby yielding a third output (e.g., 810); and updating, by the device (e.g., via 602), internal parameters of the first deep learning neural network and of the second deep learning neural network, via backpropagation based on an error between the third output and the training medical image.

In some aspects, various embodiments described herein can comprise a computer program product for facilitating curve-conditioned medical image synthesis, the computer program product comprising a non-transitory computer-readable memory (e.g., 110) having program instructions embodied therewith, the program instructions executable by a processor (e.g., 108) to cause the processor to: access a two-dimensional or three-dimensional curve (e.g., 104); execute a deep learning neural network (e.g., 202) on the two-dimensional or three-dimensional curve, thereby yielding a synthetic medical image (e.g., 204) that depicts one or more anatomical structures that resemble the two-dimensional or three-dimensional curve; and render the synthetic medical image on an electronic display. In various instances, the deep learning neural network can receive as input the two-dimensional or three-dimensional curve concatenated with a randomized array (e.g., 106), and the deep learning neural network can produce as output the synthetic medical image. In various cases, the two-dimensional or three-dimensional curve can be further concatenated with a text conditioning or with a sketch conditioning. In various aspects, the program instructions can be further executable to cause the processor to: access a training dataset (e.g., 604); and train the deep learning neural network based on the training dataset. In various instances, the deep learning neural network can comprise a stable diffusion denoiser or a stable diffusion decoder.

Although the herein disclosure mainly describes various embodiments as applying to the generation of synthetic medical images (e.g., 204), this is a mere non-limiting example. In various aspects, the herein-described teachings can be applied to the generation of any suitable synthetic images in any suitable operational context (e.g., can be applied to the generation of synthetic non-medical images; are not limited only to the generation of synthetic medical images).

Although the herein disclosure mainly describes various embodiments as applying to a deep learning neural network (e.g., 202 or 606), this is a mere non-limiting example. In various aspects, the herein-described teachings can be applied to any suitable machine learning models exhibiting any suitable artificial intelligence architectures (e.g., support vector machines, naïve Bayes, linear regression, logistic regression, decision trees, random forest).

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ artificial intelligence to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, zₙ), to a confidence that the input belongs to a class, as by f(z)=confidence(class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

The herein disclosure describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

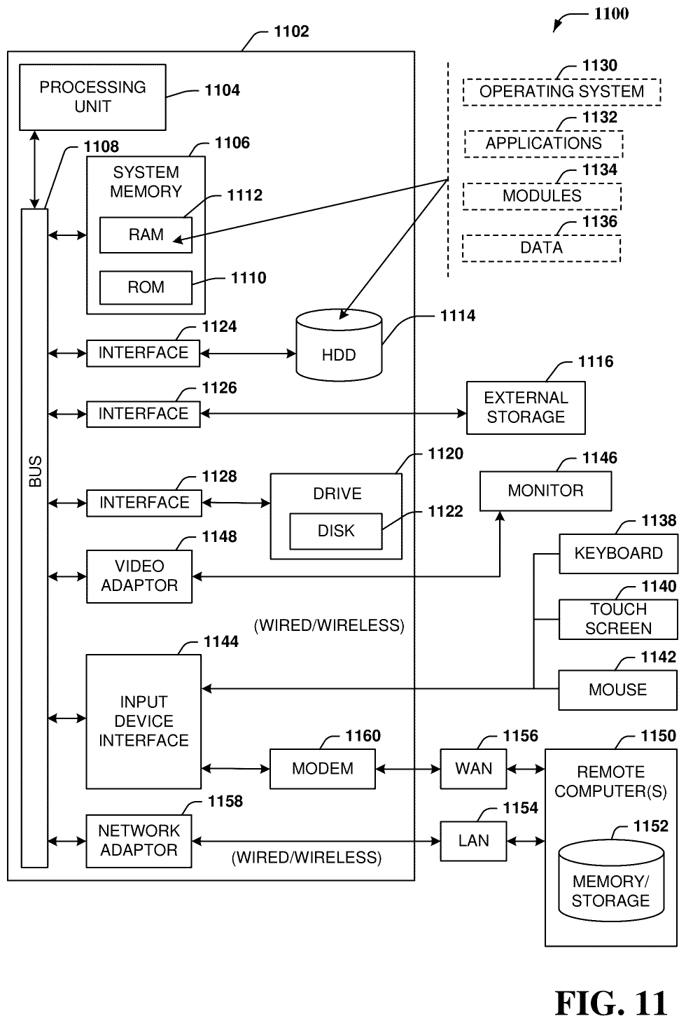

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and a drive 1120, e.g., such as a solid state drive, an optical disk drive, which can read or write from a disk 1122, such as a CD-ROM disc, a DVD, a BD, etc. Alternatively, where a solid state drive is involved, disk 1122 would not be included, unless separate. While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and drive 1120 can be connected to the system bus 1108 by an HDD interface 1124, an external storage interface 1126 and a drive interface 1128, respectively. The interface 1124 for external drive implementations can include at least one or both of

Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enable with a security module, such as a trusted processing module (TPM). For instance with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above, such as but not limited to a network virtual machine providing one or more aspects of storage or processing of information. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

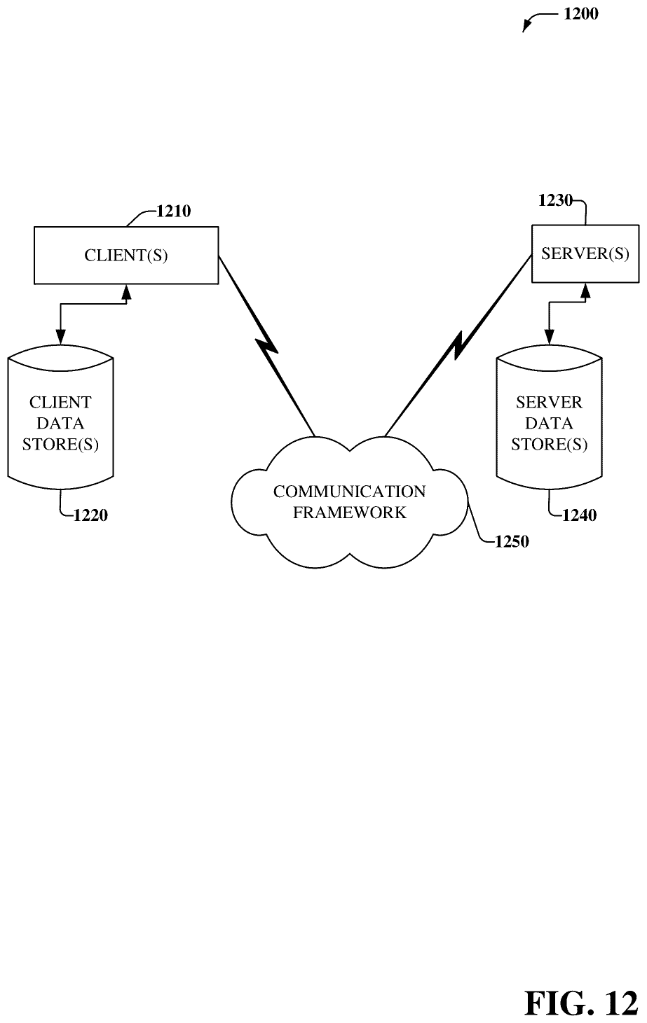

FIG. 12 is a schematic block diagram of a sample computing environment 1200 with which the disclosed subject matter can interact. The sample computing environment 1200 includes one or more client(s) 1210. The client(s) 1210 can be hardware or software (e.g., threads, processes, computing devices). The sample computing environment 1200 also includes one or more server(s) 1230. The server(s) 1230 can also be hardware or software (e.g., threads, processes, computing devices). The servers 1230 can house threads to perform transformations by employing one or more embodiments as described herein, for example. One possible communication between a client 1210 and a server 1230 can be in the form of a data packet adapted to be transmitted between two or more computer processes. The sample computing environment 1200 includes a communication framework 1250 that can be employed to facilitate communications between the client(s) 1210 and the server(s) 1230. The client(s) 1210 are operably connected to one or more client data store(s) 1220 that can be employed to store information local to the client(s) 1210. Similarly, the server(s) 1230 are operably connected to one or more server data store(s) 1240 that can be employed to store information local to the servers 1230.

The present invention may be a system, a method, an apparatus or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations or block diagrams of methods, apparatus (systems), and computer program products according to embodiments of the invention. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a processor that executes computer-executable components stored in a non-transitory computer-readable memory, the computer-executable components comprising:
an access component that accesses a user-specified geometric curve;
an inference component that generates, via execution of a first deep learning neural network on the user-specified geometric curve, a synthetic medical image whose visual characteristics are based on the user-specified geometric curve; and
a display component that renders the synthetic medical image on an electronic display.

2. The system of claim 1, wherein the first deep learning neural network receives as input the user-specified geometric curve concatenated with a randomly-generated array, and wherein the first deep learning neural network produces as output the synthetic medical image.

3. The system of claim 2, wherein the user-specified geometric curve is further concatenated with a text conditioning or a sketch conditioning.

4. The system of claim 1, wherein the user-specified geometric curve is a two-dimensional curve or a three-dimensional curve.

5. The system of claim 1, wherein the access component accesses a training dataset, and wherein the computer-executable components further comprise:
a training component that trains the first deep learning neural network based on the training dataset.

6. The system of claim 5, wherein the training dataset comprises a set of training medical images and a set of training geometric curves respectively corresponding to the set of training medical images, and wherein the training component trains the first deep learning neural network by:
selecting, from the training dataset, a training medical image and a training geometric curve that corresponds to the training medical image;
iteratively applying noise to the training medical image, thereby yielding a first output;
executing the first deep learning neural network on the first output and on the training geometric curve, thereby yielding a second output; and
updating internal parameters of the first deep learning neural network, via backpropagation based on an error between the second output and the training medical image.

7. The system of claim 5, wherein the training dataset comprises a set of training medical images and a set of training geometric curves respectively corresponding to the set of training medical images, and wherein the training component trains the first deep learning neural network by:
selecting, from the training dataset, a training medical image and a training geometric curve that corresponds to the training medical image;
executing a second deep learning neural network on the training medical image, thereby yielding a first output;
iteratively applying noise to the first output, thereby yielding a second output;
executing the first deep learning neural network on the second output and on the training geometric curve, thereby yielding a third output; and
updating internal parameters of the first deep learning neural network and of the second deep learning neural network, via backpropagation based on an error between the third output and the training medical image.

8. A computer-implemented method, comprising:
accessing, by a device operatively coupled to a processor, a user-specified geometric curve;
generating, by the device and via execution of a first deep learning neural network on the user-specified geometric curve, a synthetic medical image whose visual characteristics are based on the user-specified geometric curve; and
rendering, by the device, the synthetic medical image on an electronic display.

9. The computer-implemented method of claim 8, wherein the first deep learning neural network receives as input the user-specified geometric curve concatenated with a randomly-generated array, and wherein the first deep learning neural network produces as output the synthetic medical image.

10. The computer-implemented method of claim 9, wherein the user-specified geometric curve is further concatenated with a text conditioning or a sketch conditioning.

11. The computer-implemented method of claim 8, wherein the user-specified geometric curve is a two-dimensional curve or a three-dimensional curve.

12. The computer-implemented method of claim 8, further comprising:
accessing, by the device, a training dataset; and
training, by the device, the first deep learning neural network based on the training dataset.

13. The computer-implemented method of claim 12, wherein the training dataset comprises a set of training medical images and a set of training geometric curves respectively corresponding to the set of training medical images, and wherein the training comprises:
selecting, by the device and from the training dataset, a training medical image and a training geometric curve that corresponds to the training medical image;
iteratively applying, by the device, noise to the training medical image, thereby yielding a first output;
executing, by the device, the first deep learning neural network on the first output and on the training geometric curve, thereby yielding a second output; and
updating, by the device, internal parameters of the first deep learning neural network, via backpropagation based on an error between the second output and the training medical image.

14. The computer-implemented method of claim 12, wherein the training dataset comprises a set of training medical images and a set of training geometric curves respectively corresponding to the set of training medical images, and wherein the training comprises:
selecting, by the device and from the training dataset, a training medical image and a training geometric curve that corresponds to the training medical image;
executing, by the device, a second deep learning neural network on the training medical image, thereby yielding a first output;
iteratively applying, by the device, noise to the first output, thereby yielding a second output;
executing, by the device, the first deep learning neural network on the second output and on the training geometric curve, thereby yielding a third output; and
updating, by the device, internal parameters of the first deep learning neural network and of the second deep learning neural network, via backpropagation based on an error between the third output and the training medical image.

15. A computer program product for facilitating curve-conditioned medical image synthesis, the computer program product comprising a non-transitory computer-readable memory having program instructions embodied therewith, the program instructions executable by a processor to cause the processor to:
access a two-dimensional or three-dimensional curve;
execute a deep learning neural network on the two-dimensional or three-dimensional curve, thereby yielding a synthetic medical image that depicts one or more anatomical structures that resemble the two-dimensional or three-dimensional curve; and
render the synthetic medical image on an electronic display.

16. The computer program product of claim 15, wherein the deep learning neural network receives as input the two-dimensional or three-dimensional curve concatenated with a randomized array, and wherein the deep learning neural network produces as output the synthetic medical image.

17. The computer program product of claim 16, wherein the two-dimensional or three-dimensional curve is further concatenated with a text conditioning.

18. The computer program product of claim 16, wherein the two-dimensional or three-dimensional curve is further concatenated with a sketch conditioning.

19. The computer program product of claim 15, wherein the program instructions are further executable to cause the processor to:
access a training dataset; and
train the deep learning neural network based on the training dataset.

20. The computer program product of claim 15, wherein the deep learning neural network comprises a stable diffusion denoiser or a stable diffusion decoder.
